(19) United States
(12) Patent Application Publication
(10) Pub. No.: US 2014/0162642 A1
(43) Pub. Date: Jun. 12, 2014

(54) APPARATUS AND METHOD OF TRANSMITTING USER EQUIPMENT CAPABILITY INFORMATION IN MULTIPLE COMPONENT CARRIER SYSTEM

(71) Applicant: PANTECH CO., LTD., SEOUL (KR)

(72) Inventors: KI BUM KWON, SEOUL (KR); JAE HYUN AHN, SEOUL (KR); KANG SUK HUH, SEOUL (KR)

(73) Assignee: PANTECH CO., LTD., SEOUL (KR)

(21) Appl. No.: 13/892,089

(22) Filed: May 10, 2013

(30) Foreign Application Priority Data
May 11, 2012 (KR) 10-2012-0050205
Jun. 21, 2012 (KR) 10-2012-0066610

(51) Int. Cl. H04W 76/02

(52) U.S. Cl. CPC H04W 76/021
USPC 455/435.1

(57) ABSTRACT

A method of transmitting user equipment (UE) capability information in a multiple component carrier system by the UE is provided. The method includes receiving, from a base station (BS), a UE capability request message, and transmitting, to the BS, a UE capability response message including a supportedbandcombination field indicating one or more band combinations supported by the UE.

### CROSS-REFERENCE TO RELATED APPLICATIONS

This application claims the benefit of priority of Korean Patent Application No. 10-2012-0066610 filed on Jun. 21, 2012, and Korean Patent Application No. 10-2012-0050205 filed on May 11, 2012, all of which are incorporated by reference in its entirety herein.

### BACKGROUND OF THE INVENTION

1. Field

The present invention concerns wireless communications, and more specifically, to an apparatus and method of transmitting user equipment capability information in a multiple component carrier system.

2. Discussion of the Background

Although in a wireless communication system different bandwidths are set for downlink and uplink, respectively, only one carrier only is typically considered. Also in the 3GPP (3^{rd} Generation Partnership Project) LTE (Long Term Evolution) systems, a single carrier is based, and the number of carriers constituting downlink and uplink is one and the bandwidth of uplink is symmetrical with the bandwidth of downlink. In such a single-carrier system, a random access procedure has been performed using one carrier. However, as multiple component carrier systems have been recently introduced, the random access procedure may be implemented using several component carriers.

The multiple component carrier system means a wireless communication system that may support carrier aggregation. The “carrier aggregation” is a technology allowing pieced tiny bandwidths to be efficiently used and enables a number of continuous or non-continuous bands to be tied in the frequency domain, thus showing the same effects as if a large band is logically used.

However, the introduction of multiple component carrier systems led to the need for a procedure of individually securing uplink synchronization of each component carrier. This is why a signal delay per component carrier may vary depending on frequency band characteristics. Without securing per-component carrier uplink sync, the base station may not correctly receive uplink signals transmitted from the user equipment. To secure per-component carrier uplink sync, the random access procedure may be adopted, and based on this, the user equipment may obtain a timing alignment value that is supposed to each component carrier. The problem is that even when the base station calculates the timing alignment value per component carrier and provides it to the user equipment, the user equipment sometimes may not actually apply multiple-timing alignment values to communication due to a restriction on is capability of the user equipment. That is, in light of the user equipment's hardware structure, the user equipment may be divided into some having capability of being able to secure uplink sync per component carrier and others having no such capability.

The base station should be aware of whether the user equipment supports uplink sync for each of a number of component carriers and a protocol should be defined between the user equipment and the base station so that it may be known to the base station.

### SUMMARY OF THE INVENTION

An object of the present invention is to provide an apparatus and method of transmitting capability information of user equipment in a multiple component carrier system.

Another object of the present invention is to provide an apparatus and method of transmitting information on the maximum number of TAGs and a combination of frequency bands that may be supported to the user equipment.

Still another object of the present invention is to provide a method of transmitting, through capability information of the user equipment, information on whether the user equipment supports multiple-timing alignment.

Yet still another object of the present invention is to provide an apparatus and method of configuring information indicating whether multiple-timing alignment is supported.

In an aspect of the present invention, a method of transmitting user equipment (UE) capability information in a multiple component carrier system by the UE is provided. The method includes receiving a UE capability request message from a base station (BS), and transmitting, to the BS, a UE capability response message, which includes a supportedbandcombination field indicating one or more band combinations supported by the UE, and multiple timing advance (MTA) capability field indicating each of multiple timing advances is supported by the UE corresponding to each of the one or more band combinations.

In another aspect of the present invention, a user equipment (UE) for transmitting a UE capability transfer procedure in a multiple component carrier system is provided. The UE includes an RF unit to receive, from a base station (BS), a UE capability request message, and a message processor to configure a UE capability response message including a supportedbandcombination field indicating one or more band combinations supported by the UE, and multiple timing advance (MTA) capability field indicating each of multiple timing advances supported by the UE corresponding to each of the one or more band combinations.

In yet another aspect of the present invention, a method of receiving user equipment (UE) capability information in a multiple component carrier system by a base station (BS) is provided. The method includes transmitting a UE capability request message to a UE, and receiving, from the UE, a UE capability response message, which includes a supportedbandcombination field indicating one or more band combinations supported by the UE, and multiple timing advance (MTA) capability field indicating each of multiple timing advances supported by the UE corresponding to each of the one or more band combinations.

In yet another aspect of the present invention, a base station (BS) for receiving user equipment (UE) capability information in a multiple component carrier system is provided. The BS includes a message processor to generate a UE capability request message, and an radio frequency (RF) unit to transmit, to a UE, the UE capability request message and to receive, from the UE, a UE capability response message, including a supportedbandcombination field indicating one or more band combinations supported by the UE and multiple timing advance (MTA) capability field indicating each of multiple timing advances supported by the UE corresponding to each of the one or more band combinations.

### BRIEF DESCRIPTION OF THE DRAWINGS

FIG. 1 shows a wireless communication system to which the present invention applies.

FIG. 2 shows an example of a protocol structure for supporting a multiple component carrier to which the present invention applies.

FIG. 3 shows an example of a frame structure for operating a multiple component carrier to which the present invention applies.

FIG. 4 shows a linkage between a downlink component carrier and an uplink component carrier in a multiple component carrier system to which the present invention applies.

FIG. 5 is a flowchart illustrating a signaling procedure regarding multiple-timing alignment capability according to an embodiment of the present invention.

FIG. 6 is a view illustrating the structure of user equipment supporting multiple-timing alignment according to an embodiment of the present invention.

FIG. 7 is a view illustrating the structure of user equipment supporting multiple-timing alignment according to another embodiment of the present invention.

FIG. 8 is a view illustrating the structure of user equipment supporting multiple-timing alignment according to still another embodiment of the present invention.

FIG. 9 is a flowchart illustrating a process of obtaining a multiple-timing alignment value according to an embodiment of the present invention.

FIG. 10 is a flowchart illustrating a method of transmitting user equipment capability information by user equipment according to an embodiment of the present invention.

FIG. 11 is a flowchart illustrating a method of receiving user equipment capability information by a base station according to an embodiment of the present invention.

FIG. 12 is a block diagram illustrating user equipment and a base station transmitting and receiving user equipment capability information according to an embodiment of the present invention.

### DETAILED DESCRIPTION OF THE ILLUSTRATED EMBODIMENTS

Hereinafter, some embodiments of the present invention will be described with reference to the accompanying drawings. It should be noted that the same reference numerals are used to denote the same components throughout the drawings and the specification. When determined to render the subject matter of the specification unclear, the description of known configurations or functions is skipped.

Further, in this disclosure, the description chiefly focuses on the radio communication network, and task in the radio communication network may be performed while controlling the network or transmitting data in a system (e.g., base station) in charge of the corresponding radio communication network or in user equipment attached to the corresponding radio network. According to the present invention, the wireless communication system may include a communication system that supports one or more component carriers.

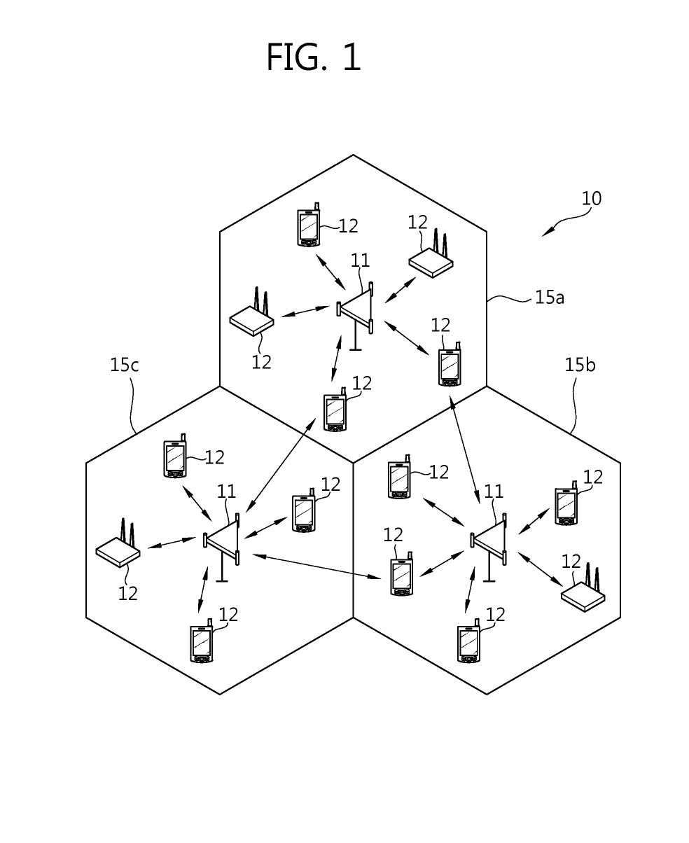

FIG. 1 shows a wireless communication system to which the present invention applies.

Referring to FIG. 1, the wireless communication system 10 is widely arranged to to provide various communication services such as voice or packet data. The wireless communication system 10 includes at least one base station (BS) 11. Each base station 11 provides communication services in a specific cell 15a, 15b, and 15c. The cell may be divided into a plurality of regions (referred to as sectors).

The user equipment (UE) 12 may be stationary or mobile, and may be referred to by other terms such as MS (Mobile Station), MT (mobile terminal), UT (user terminal), SS (subscriber station), wireless device, PDA (personal digital assistant), wireless modem, or handheld device. The base station 11 may be referred to by other terms such as eNB (evolved-NodeB), BTS (Base Transceiver System), access point, femto base station, Home nodeB, or relay. The cell should be interpreted as comprehensive meaning representing some area covered by the base station 11 and includes, in light of concept, all of various coverage areas such as mega cell, macro cell, micro cell, pico cell, or femto cell.

Hereinafter, the downlink means communication from the base station 11 to the user equipment 12, and the uplink means communication from the user equipment 12 to the base station 11. In the downlink, the transmitter may be part of the base station 11, and the receiver may be part of the user equipment 12. In the uplink, the transmitter may be part of the user equipment 12, and the receiver may be part of the base station 11. The wireless communication system may use various multiple access schemes including, but not limited to, CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, or OFDM-CDMA. For uplink transmission and downlink transmission, a TDD (Time Division Duplex) scheme in which uplink transmission and downlink transmission are performed in different times and an FDD (Frequency Division Duplex) scheme in which uplink transmission and downlink transmission are performed at different frequencies may be used.

The carrier aggregation (CA) is to support a plurality of carriers and is also referred to as spectrum aggregation or bandwidth aggregation. The carrier aggregation is a technology allowing pieced tiny bands to be efficiently used and may tie a plurality of physically is continuous or non-continuous bands in the frequency domain to show as if a logically large band is used. The individual unit carriers tied by the carrier aggregation are referred to as component carriers (CC). Each component carrier is defined with a bandwidth and a center frequency. The carrier aggregation has been introduced to support increasing throughput, to prevent an increase in costs due to introduction of wideband RF (Radio Frequency) elements, and to insure compatibility with existing systems. For example, if five component carriers are allocated as granularity of a carrier unit having a bandwidth of 20 MHz, a maximum of 100 MHz bandwidth may be supported.

The carrier aggregation may be divided into contiguous carrier aggregation that is performed between contiguous component carriers in the frequency domain and non-contiguous carrier aggregation that is performed between non-contiguous component carriers. The number of carriers aggregated for downlink may be set to be different from the number of carriers aggregated for uplink. The case where the number of downlink component carriers is the same as the number of uplink component carriers is referred to as symmetric aggregation, and the case where the number of downlink component carriers is different from the number of uplink component carriers is referred to as asymmetric aggregation.

The component carriers may be different in size from each other. For example, when five component carriers are used to configure a band of 70 MHz, it may be constituted of 5 MHz component carrier (carrier #0)+20 MHz component carrier (carrier #1)+20 MHz component carrier (carrier #2)+20 MHz component carrier (carrier #3)+5 MH component carrier (carrier #4).

Hereinafter, the “multiple component carrier system” refers to a system including user equipment and base station supporting carrier aggregation. In the multiple component carrier system, contiguous carrier aggregation and/or non-contiguous carrier aggregation may be adopted or symmetric or non-symmetric aggregation, either way, may be used.

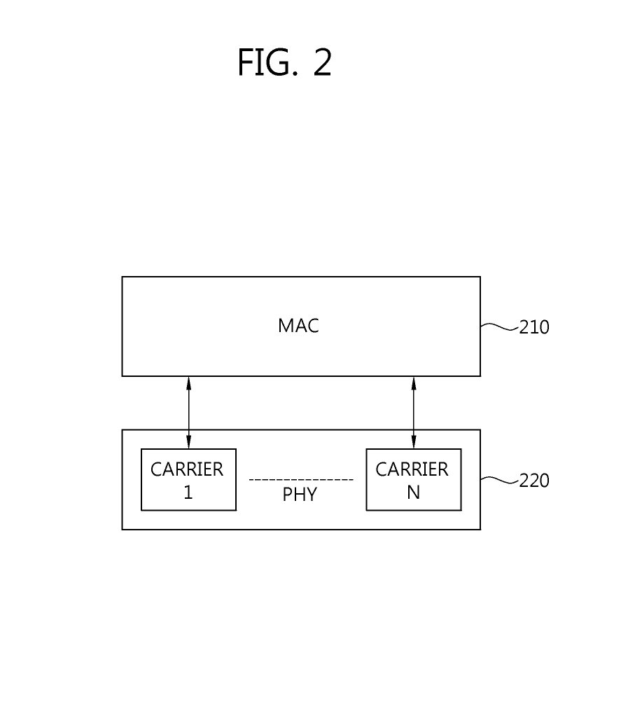

FIG. 2 shows an example of a protocol structure for supporting a multiple component carrier to which the present invention applies.

Referring to FIG. 2, a medium access control (MAC) entity 210 manages a physical layer 220 using a plurality of carriers. An MAC management message transmitted over a specific carrier may apply to other carriers. That is, the MAC management message is a message that may control other carriers including the specific carrier. The physical layer 220 may operate in TDD (Time Division Duplex) and/or FDD (Frequency Division Duplex).

There are a few physical channels used in the physical layer 220.

First, as a downlink physical channel, PDCCH (Physical Downlink Control Channel) informs the user equipment of HARQ (Hybrid Automatic Repeat Request) information relating to DL-SCH and resource allocation of PCH (Paging Channel) and DL-SCH (Downlink Shared Channel). PDCCH may carry an uplink grant that informs the user equipment of resource allocation of uplink transmission. PDSCH (physical downlink shared channel) is mapped with DL-SCH. PCFICH (Physical Control Format Indicator Channel) informs the user equipment of the number of OFDM symbols used in PDCCHs and is transmitted per subframe. PHICH (Physical Hybrid ARQ Indicator Channel) is a downlink channel and carries HARQ ACK/NACK signals that are responses to uplink transmission.

Next, as an uplink physical channel, PUCCH (Physical Uplink Control Channel) carries uplink control information such as HARQ ACK/NACK signals for downlink transmission and uplink control information such as scheduling request and CQI. PUSCH (Physical Uplink Shared Channel) carries UL-SCH (Uplink Shared Channel). PRACH (Physical Random Access Channel) carries a random access preamble.

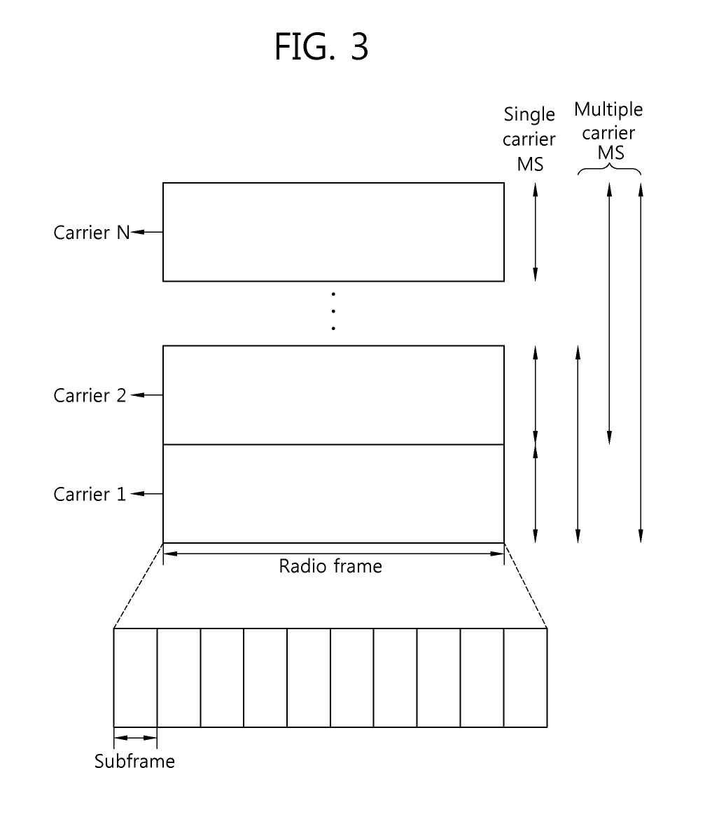

FIG. 3 shows an example of a frame structure for operating a multiple component carrier to which the present invention applies.

Referring to FIG. 3, one frame consists of ten subframes. The subframe may include a plurality of OFDM symbols along the time axis and at least one component carrier along the frequency axis. Each component carrier may have its own control channel (e.g., PDCCH). Multiple component carriers may be contiguous or non-contiguous to each other. The user equipment, depending on its capability, may support one or more component carriers.

The component carriers may be classified into primary component carriers (PCCs) and secondary component carriers (SCCs). The user equipment uses only one primary component carrier or may use one or more secondary component carriers, together with a primary component carrier. The user equipment may be allocated with a primary component carrier and/or a secondary component carrier from the base station. The component carrier may be represented as cell or serving cell. Unless explicitly expressed as downlink component carrier or uplink component carrier, the component carrier may be configured as having both downlink component carrier and uplink component carrier or as downlink component carrier alone.

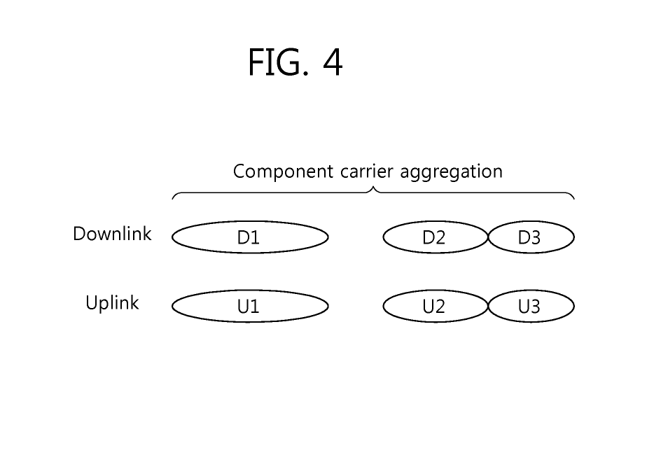

FIG. 4 shows a linkage between a downlink component carrier and an uplink component carrier in a multiple component carrier system to which the present invention applies.

Referring to FIG. 4, downlink component carriers D1, D2, and D3 are aggregated on downlink, and uplink component carriers U1, U2, and U3 are aggregated on uplink. Here, Di is an index of a downlink component carrier, and Ui is an index of an uplink component carrier (i=1, 2, 3). At least one downlink component carrier is a primary component carrier, and the others are secondary component carriers. Likewise, at least one uplink component carrier is a primary component carrier, and the others are secondary component carriers. For example, D1 and U1 are primary component carriers, and D2, U2, D3, and U3 are secondary component carriers. Here, the index of the primary component carrier may be set as 0, and a natural number other than 0 may be an index of the secondary component carrier. Further, the index of the downlink/uplink component carrier may be set to be the same as the index of a component carrier (or serving cell) including the corresponding downlink/uplink component carrier. As another example, only the component carrier index or secondary component carrier index is set while no uplink/uplink component carrier index may exist that is included in the corresponding component carrier.

In the FDD system, the downlink component carrier and the uplink component carrier may be linked to each other in a one-to-one relationship. For example, one-to-one linkage may be established between D1 and U1, between D2 and U2, and between D3 and U3. The user equipment forms linkages between the downlink component carriers and the uplink component carriers through system information transmitted over logical channel BCCH or user equipment-dedicated RRC message transmitted over DCCH. Such linkages are referred to as SIB1 (System Information Block 1) linkage or SIB2 (System Information Block 2) linkage. Each linkage may be configured cell specifically or UE-specifically. As an example, the primary component carrier is cell-specifically configured, and the secondary component carrier may be UE-specifically configured.

FIG. 4 only shows an example of 1:1 linkage between the downlink component carrier and the uplink component carrier. However, linkages such as 1:n or n:1 may also be formed, of course. Further, the index of the component carrier is not always consistent with order of component carriers or position of frequency band of the corresponding component carrier.

The primary serving cell means one serving cell that provides NAS mobility information and security input in the state of RRC establishment or reconfiguration. Depending on capabilities of the user equipment, at least one cell may be configured to form a serving cell aggregation, together with the primary serving cell. The cell is referred to as secondary serving cell.

Accordingly, a serving cell aggregation configured by one user equipment may consist of only one primary serving cell or of one primary serving cell and at least one secondary serving cell.

The downlink component carrier corresponding to the primary serving cell is referred to as downlink primary component carrier (DL PCC), and the uplink component carrier corresponding to the primary serving cell is referred to as uplink primary component carrier (UL PCC). Further, in the downlink, the component carrier corresponding to the secondary serving cell is referred to as downlink secondary component carrier (DL SCC), and in the uplink, the component carrier corresponding to the secondary serving cell is referred to as uplink secondary component carrier (UL SCC). Only the downlink component carrier or both DL CC and UL CC may correspond to one serving cell.

Accordingly, communication between the user equipment and the base station being done through DL CC or UL CC in the carrier system is the same in concept as communication between the user equipment and the base station being done through the serving cell. For example, in a method of performing random access according to the present invention, the user equipment transmitting a preamble over UL CC is equivalent in concept to transmitting a preamble over primary serving cell or secondary serving cell. Further, the user equipment receiving downlink information over DL CC is equivalent in concept to receiving downlink information over primary serving cell or secondary serving cell.

Meanwhile, the primary serving cell and secondary serving cell have the following characteristics.

First, the primary serving cell is used to transmit PUCCH. In contrast, the secondary serving cell may not transmit PUCCH but may transmit some control information of information in PUCCH through PUSCH.

Second, the primary serving cell always remains activated while the secondary serving cell shifts between activated and deactivated depending on specific conditions. The specific conditions may be when receiving an indicator indicating activation/deactivation from the base station or when a deactivation timer in the user equipment expires. The “activation” means when traffic data is being transmitted or received or is ready for transmission or reception of the traffic data. The “deactivation” means when it is impossible to transmit or receive traffic data and control information for the traffic data and to perform measurement and report to generate downlink channel status information while minimum measurement or transmission/reception of minimum information may be possible. For example, measurement on, e.g., reference signal received power for calculating path loss and reception of physical control format indicator channel (PCFICH) indicating an area where control information is transmitted through downlink of the corresponding serving cell may be possible.

Third, when the primary serving cell experiences radio link failure (hereinafter, “RLF”), RRC reconfiguration is triggered, but when the secondary serving cell experiences RLF, RRC reconfiguration is not triggered. The radio link failure occurs when the downlink capability is left at a threshold value or less for a predetermined time or more, or when RACH fails a number of times that is the same as a threshold value or more.

Fourth, the primary serving cell may be varied by a handover procedure that comes together with an RACH procedure or change in security key. However, in the case of a contention resolution (CR) message, only PDCCH indicating the contention resolution message should be transmitted through the primary serving cell, while the contention resolution message may be transmitted through the primary serving cell or secondary serving cell.

Fifth, NAS (Non-Access Stratum) information is received through the primary serving cell.

Sixth, the primary serving cell always has DL PCC and UL PCC configured in pair.

Seventh, a CC that is different per user equipment may be set as the primary serving cell.

Eighth, procedures such as reconfiguration, adding, and removal of the secondary serving cell may be conducted by a radio resource control (RRC) layer. In adding a new secondary serving cell, system information of a dedicated secondary serving cell may be transmitted using RRC signaling. As an example, an RRC connectionreconfiguration procedure may be used as the RRC signaling.

Ninth, the primary serving cell may provide both PDCCH (e.g., downlink allocation information or uplink grant information) allocated to a UE-specific search space configured to transmit control information only to specific user equipment in an area where control information is transmitted and PDCCH (e.g., system information (SI), random access response (RAR), transmit power control (TPC)) allocated to a common search space configured to transmit control information to a number of user equipment satisfying a specific condition or all user equipment in the cell. On the contrary, only the UE-specific search space may be configured for the secondary serving cell. In other words, since the user equipment may not verify the common search space through the secondary serving cell, the user equipment may not receive control information transmitted only through the common search space and data information indicated by the control information.

Among the secondary serving cells, a secondary serving cell in which the common search space (CSS) may be defined may be present. Such secondary serving cell is denoted “special secondary serving cell (SCell)”. The special secondary serving cell, upon cross carrier scheduling, is always set as a scheduling cell. Further, PUCCH configured for the primary serving cell may be defined for the special secondary serving cell.

The PUCCH for the special secondary serving cell may be fixedly configured when configuring the special secondary serving cell or may be allocated (configured) or released by an RRC signaling (RRC reconfiguration message) when the base station re-establishes the corresponding secondary serving cell.

The PUCCH for the special secondary serving cell includes ACK/NACK information or CQI (Channel Quality Information) of the secondary serving cells present in the corresponding sTAG, and as mentioned above, may be configured through RRC signaling by the base station.

Further, the base station may configure one special secondary serving cell among a plurality of secondary serving cells in the sTAG or may not configure the special secondary serving cell. The reason why the base station does not configure the special secondary serving cell is that CSS and PUCCH are determined to be unnecessary. As an example, such case may include when it is determined that the contention-based random access procedure need not be performed on any secondary serving cell or when the capability of the PUCCH of the current primary serving cell is determined to be enough so that it is not needed to configure PUCCH for an additional secondary serving cell.

The technical spirit of the present invention relating to the features of the primary serving cell and secondary serving cell is not limited to what has been described above, and this is merely an example, and more examples may be rather included therein.

In the radio communication environment, propagation delay occurs while radio waves are propagated from the transmitter to the receiver. Accordingly, although the transmitter and the receiver both are exactly aware of the time that the radio waves are propagated from the transmitter, the time that the waves arrive at the receiver is influenced by distance between the transmitter and the receiver or peripheral propagation environment, and in case the receiver is on the move, the time is varied with time. If the receiver cannot correctly figure out the time that it receives a signal transmitted from the transmitter, signal reception fails, or even when it succeeds, the receiver may receive a distorted signal, thus resulting in the communication being impossible.

Accordingly, in the wireless communication system, sync between the base station and the user equipment should be first achieved to receive signals whichever on uplink or downlink. There may be various types of sync including frame sync, information symbol sync, and sampling period sync. The sampling period sync should be most basically achieved to discern physical signals from each other.

Downlink sync is achieved by the user equipment based on a signal from the base station. The base station transmits a mutually promised specific signal to allow the user equipment to easily obtain sync. The user equipment should exactly identify the time that the specific signal was transmitted from the base station. Since in the case of downlink one base station simultaneously transmits the same sync signal to a plurality of user equipment, the user equipment each may independently obtain sync. Here, the mutually promised signal includes a primary sync signal (PSS), a secondary sync signal (SSS), and a cell reference signal (CRS).

Further, in case a plurality of serving cells are configured for the user equipment, the user equipment may obtain downlink sync independently for each serving cell. If there is a serving cell (extended serving cell (ECell)) that does not transmit the mutually promised specific signal to facilitate obtaining downlink sync among the serving cells, a reference serving cell may be configured for the user equipment in order to refer to downlink sync for the serving cell. The configuration of the reference serving cell may be variably done by RRC signaling, may be fixedly achieved as a primary serving cell and may become a timing reference cell. The ECell may not be a timing reference cell.

In the case of uplink, the base station receives signals transmitted from a plurality of user equipment. In case the distance between each user equipment and the base station is different from the distance between another user equipment and the base station, the signals received by the base station have different signal delays from each other, and in case uplink information is transmitted based on each obtained downlink sync, the information of each user equipment is received by the base station at a time different from a time when information of another user equipment is received by the base station. In such case, the base station may not obtain sync based on any one of the user equipment. Accordingly, a different procedure from the procedure for obtaining the downlink sync is needed for obtaining uplink sync.

A random access procedure is performed to obtain uplink sync. While the random access procedure is in progress, the user equipment obtains uplink sync based on a timing alignment value transmitted from the base station. From the point of view that it has a value of putting the uplink time forward, the timing alignment value may also be called “time advanced value.” The random access preamble is used to obtain a timing alignment value for syncing the uplink time of the secondary serving cell.

When receiving a random access response message including the timing alignment value or obtaining uplink sync, the user equipment initiates a time alignment timer. If the time alignment timer is in operation, the user equipment determines that the user equipment and the base station are in uplink sync with each other. If the time alignment timer expires or does not work, the user equipment deems this as the user equipment and the base station being not uplink synced with each other and does not perform uplink transmission other than transmission of the random access preamble.

Meanwhile, in a multiple component carrier system, one user equipment performs communication with a base station through a plurality of component carriers or a plurality of serving cells. If signals transmitted from the user equipment to the base station through the plurality of serving cells have the same time delay, the user equipment may obtain uplink sync on all the serving cells with one timing alignment value. On the contrary, if signals transmitted to the base station through the plurality of serving cells have different time delays from each other, a different timing alignment value is needed for each serving cell. In such case, there may be a number of timing alignment values, which are referred to as multiple-timing alignment values. An uplink sync procedure associated with the multiple-timing alignment values is referred to as “multiple-timing alignment (M-TA)” or “multiple-timing advance (M-TA)”.

If the user equipment performs random access procedure on each of the serving cells to obtain the multiple-timing alignment values, the number of random access procedures required to obtain uplink sync increases, and thus, overhead occurs on the limited uplink and downlink resources and complexity of a sync tracking process for maintaining the uplink sync may be on the rise. To reduce such overhead and complexity, a timing alignment group (TAG) is defined. The timing alignment group may also be referred to as time advance group.

TAG is a group of serving cell(s) using the same timing alignment value and the same timing reference or a timing reference cell including the timing reference among serving cells in which uplink is configured. Here, the timing reference may be DL CC that is a reference for calculating the timing alignment value. For example, in case a first serving cell and a second serving cell belong to TAG1, and the second serving cell is a timing reference cell, the same timing alignment value TA1 applies to the first and second serving cells, and the first serving cell applies the TA1 value from the time of DL CC downlink sync of the second serving cell. In contrast, if the first serving cell and the second serving cell belong to TAG1 and TAG2, respectively, the first serving cell and the second serving cell respectively become timing reference cells in the corresponding TAGs, and different timing alignment values TA1 and TA2 apply to the first and second serving cells, respectively. The TAG may include a primary serving cell, may include at least one secondary serving cell, or may include a primary serving cell and at least one secondary serving cell.

Each TAG includes at least one serving cell in which UL CC is configured. Information on the serving cell mapped with each TAG is referred to as TAG configuration information. The TAG, when first group configuration and group re-configuration is determined by the serving base station that has configured the corresponding serving cell, transmits it to the user equipment through RRC signaling.

The primary serving cell does not vary TAG. Further, the user equipment, in case multiple-timing alignment values are needed, should support at least two TAGs. As an example, the user equipment should support TAGs that are divided into a pTAG (primary TAG) including the primary serving cell and a sTAG (secondary TAG) not including the primary serving cell. Here, there is always only one pTAG, and there may be at least one or more sTAGs when multiple-timing alignment values are needed. In other words, if multiple-timing alignment values are needed, a plurality of TAGs may be configured. For example, the maximum number of TAGs may be four. Further, pTAG always has TAG ID=O or may be configured to have no value.

The serving base station and the user equipment may perform the following operations to obtain and maintain timing alignment (TA) values for the TAGs.

1. The serving base station and the user equipment obtain and maintain timing alignment value of pTAG through the primary serving cell. Further, the timing reference that is a reference for calculating and applying the TA value of pTAG always becomes DL CC in the primary serving cell.

2. To obtain an initial uplink timing alignment value for sTAG, non-contention based RA procedure initialized by the base station is used.

3. One of activated secondary serving cells may be used as timing reference for sTAG, but under the assumption that there is no unnecessary change in timing reference.

4. Each TAG has one timing reference and one time alignment timer (TAT). Each TAT may have a different timer expiration value. The TAT starts or restarts immediately after the timing alignment value is obtained from the serving base station in order to indicate validity of the timing alignment value obtained and applied by each TAG.

5. If the TAT of the pTAG is not in progress, the TATs for all the sTAGs should not be in progress. In other words, in case the TAT of the pTAG expires, all of the TATs of all the TAGs including the pTAG expire, and when the TAT for the pTAG is not in progress, the TATs for all the sTAGs cannot be initiated.

A. if the TAT of pTAG expires, the user equipment flushes HARQ buffers of all the serving cells. Further, the user equipment initializes (clear) the resource allocation configurations on all the downlinks and uplinks. As an example, in case periodic resource allocation is configured without control information transmitted aiming to perform resource allocation on the downlink/uplink such as PDCCH like the semi-persistent scheduling (SPS) scheme, the above SPS configuration is initialized. Further, it releases PUCCHs of all the serving cells and type 0 (periodic) SRS configuration.

6. If the TAT of sTAG only expires, the following procedures are performed.

A. SRS transmission through UL CCs of secondary serving cells in sTAG is paused.

B. type 0 (periodic) SRS configuration is released. Type 1 (non-periodic) SRS configuration is maintained.

C. configuration information for CSI report is maintained.

D. HARQ buffers for uplink of secondary serving cells in sTAG are flushed.

7. In case the TAT for sTAG is in progress, even when all secondary serving cells in the sTAG remain deactivated, the user equipment lets the TAT of the corresponding sTAG go on without pause. This means that even under the situation where all the secondary serving cells in sTAG are left deactivated so that any SRS and uplink transmission to track the uplink sync are not achieved for a specific time, validity of the TA value of the corresponding sTAG may be ensured through the TAT.

8. In case the last secondary serving cell in the sTAG is removed, that is, when no secondary serving cell is configured in the sTAG, the TAT of the corresponding sTAG is stopped.

9. The random access procedure for the secondary serving cell may be performed by the base station transmitting a PDCCH order instructing start of the random access procedure through PDCCH that is a physical layer control information channel on the activated secondary serving cell. The PDCCH order includes random access preamble index information that may be used in the secondary serving cell in the sTAG of the corresponding user equipment and PRACH mask index information allowing transmission of the random access preamble on all or some of time/frequency resources available in the corresponding secondary serving cell. Accordingly, the random access procedure for the secondary serving cell proceeds only through a non-contention based random access procedure. Here, the random access preamble information included in the PDCCH order to instruct the non-contention based random access procedure should be indicated with information other than ‘000000’.

10. PDCCH and PDSCH for transmitting random access response (RAR) message may be transmitted through the primary serving cell.

11. in case the number of times of re-transmission of random access preamble of the secondary serving cell reaches the maximum allowable re-transmission count: A) the MAC layer stops the random access procedure. B) The MAC layer does not inform the RRC layer of failure to random access. Accordingly, RLF (Radio Link Failure) is not triggered. C) The user equipment does not inform the base station of failure to random access of the secondary serving cell.

12. A path-attenuation reference of pTAG may become the primary serving cell or secondary serving cell in pTAG, and the base station may make a different configuration on each serving cell in pTAG through RRC signaling.

13. The path-attenuation references of uplink CCs of the serving cells in sTAG are respectively SIB2-linked downlink CCs. Here, the “being SIB2-linked” means that linkage between DL CC configured based on information in SIB1 of the corresponding secondary serving cell and UL CC configured based on information in SIB2. Here, SIB2 is one of system information blocks transmitted through a broadcasting channel, and SIB2 is transmitted from the base station to the user equipment through an RRC reconfiguration procedure when configuring the secondary serving cell. Uplink center frequency information is included in SIB2, and downlink center frequency information is included in SIB1.

The user equipment is released in various hardware structures. Although the base station may calculate multiple-timing alignment values regarding a plurality of serving cells configured for the user equipment, the multiple-timing alignment values, in many cases, may not be applicable to actual communication due to restriction on capability of the user equipment. That is, there are, in light of hardware structure, user equipment supporting multiple-timing alignment and user equipment not supporting multiple-timing alignment. Accordingly, the base station should be aware of whether the user equipment supports multiple-timing alignment in order to smoothly operate the multiple component carrier system and a protocol should be defined between the user equipment and the base station so that it may be known.

In a simple way, if the user equipment signals information regarding whether the user equipment supports multiple-timing alignment (M-TA), and if supporting the multiple-timing alignment, in what extent or in what form the multiple-timing alignment may be supported to the base station, the base station may perform multiple-timing alignment with the user equipment based on the signaling or may not. The capability of the user equipment supporting the multiple-timing alignment is referred to as multiple-timing alignment capability (M-TA capability).

For purposes of signaling relating to the multiple-timing alignment capability, an RRC layer message may be used. More specifically, a procedure of transferring the user equipment's capability may be used for performing signaling regarding the multiple-timing alignment capability. The user equipment's capability information is used to inform the network of radio access capabilities such as the basic hardware capability or physical capability of the user equipment. Since the multiple-timing alignment capability is closely associated with the hardware structure of the user equipment, the user equipment's capability information defining the hardware structure of the user equipment may be configured to include information regarding the multiple-timing alignment capability or signaling.

Hereinafter, a method of configuring multiple-timing alignment capability information is described in detail.

1. Per-User Configuration of Equipment Multiple-Timing Alignment Capability Information

The multiple-timing alignment capability information may be defined on a per-m user equipment basis and may display whether the user equipment is supportive of multiple-timing alignment capability in an ON/OFF manner. For example, ON represents that the user equipment may support multiple-timing alignment, and OFF represents that the user equipment may not support multiple-timing alignment. The multiple-timing alignment capability information having such form may be applied when supporting the multiple-timing alignment is considered in intra-band carrier aggregation as well as inter-band carrier aggregation. In light of the RF hardware structure of general user equipment, the user equipment having a single RF may have difficulty in supporting multiple-timing alignment or may not support multiple-timing alignment. Accordingly, according to the type of RF implemented in the user equipment, the multiple-timing alignment may be defined on a per-user equipment basis.

As an example, the multiple-timing alignment capability information may have the fields as represented in the following table:

TABLE 1

| | |
|---|---|
| multipleTimingAdvance | ENUMERATED {supported} |
| OPTIONAL, | |

Referring to Table 1, the multipleTimingAdvance field is multiple-timing alignment capability information. OPTIONAL means that the multipleTimingAdvance field may be selectively included in the upper field. The upper field is a field including the multipleTimingAdvance field. The user equipment may or may not include the multipleTimingAdvance field in the upper field. For example, the multipleTimingAdvance field being included in the upper field means that the user equipment supports the multiple-timing alignment. In case the multipleTimingAdvance field is included in the upper field, it may represent that all multiple-timing alignments that occur in all the band combinations supportable by the user equipment may be supported. On the contrary, the multipleTimingAdvance field being not included in the upper field means that the user equipment does not support the multiple-timing alignment.

If the multipleTimingAdvance field is included in the upper field, the base station may be aware that the user equipment may support the multiple-timing alignment. In contrast, if the multipleTimingAdvance field is not included in the upper field, the base station may be aware that the user equipment may not support the multiple-timing alignment.

As another example, the multiple-timing alignment capability information may have fields as represented in the following table:

TABLE 2

| | |
|---|---|
| maxMultipleTimingAdvance | Integer(1...4) |
| OPTIONAL, | |

Referring to FIG. 2, the maxMultipleTimingAdvance field is multiple-timing alignment capability information. OPTIONAL means that the maxMultipleTimingAdvance field may be selectively included in the upper field. That is, the user equipment may or may not include the maxMultipleTimingAdvance field in the upper field. The maxMultipleTimingAdvance field being included in the upper field means that the user equipment supports multiple-timing alignment. At this time, Integer(1 . . . 4) indicates the number of multiple-timing alignments maximally supportable by the user equipment. For example, Integer(3) represents that the maximum number of multiple-timing alignments supportable by the user equipment is 3. Meanwhile, the maxMultipleTimingAdvance field being not included in the upper field means that the user equipment does not support multiple-timing alignment. Integer(1 . . . 4) is merely an example, and the maximum number of multiple-timing alignments supportable may be four or more or less.

As still another example, the multiple-timing alignment capability information may have fields as represented in the following table:

TABLE 3

| multipleTimingAdvance SEQUENCE { | |
|---|---|
| maxMultipleTimingAdvance | Integer(1...4) |
| } OPTIONAL, | |

Referring to Fig. Table 3, the multiple-timing alignment capability information includes a multipleTimingAdvance field and a maxMultipleTimingAdvance field. The multipleTimingAdvance field and the maxMultipleTimingAdvance field are selectively included in the upper field. The multipleTimingAdvance field and the maxMultipleTimingAdvance field being included in the upper field indicates that the user equipment supports up to 1-4 multiple-timing alignments. Integer(1 . . . 4) is merely an example, and the maximum number of multiple-timing alignments supportable may be four or more or less. The multipleTimingAdvance field and the maxMultipleTimingAdvance field being not included in the upper field indicates that the user equipment does not support multiple-timing alignment.

The upper field including the multiple-timing alignment capability information in Tables 1 to 3 may be, e.g., a PhyLayerParameters field that represents a physical layer parameter of the user equipment. Or, the upper field including the multiple-timing alignment capability information in Tables 1 to 3 may be, e.g., an RF-Parameters field indicating RF parameter characteristics implemented in the user equipment. Or, the upper field including the multiple-timing alignment capability information in Tables 1 to 3 may be, e.g., an E-UTRA capability (UE-EUTRA-Capability) of the user equipment as used in a user equipment capability transfer procedure.

2. Per-Band Configuration of Multiple-Timing Alignment Capability Information

The user equipment may indicate whether to support multiple-timing alignment per band not per user equipment. For example, it may be indicated in an ON/OFF manner whether each band supports multiple-timing alignment. Carrier aggregation may be generally divided into inter-band carrier aggregation and intra-band carrier aggregation. The multiple-timing alignment capability presumes carrier aggregation and thus whether multiple-timing alignment capability is supported may be determined differently depending on the inter-band carrier aggregation and intra-band carrier aggregation, and different signaling schemes may apply.

(1) Inter-Band Carrier Aggregation and Multiple-Timing Alignment Capability Information

As an example, whether multiple-timing alignment is supported in the user equipment supporting inter-band carrier aggregation may be explicitly indicated by an inter-band multiple-timing alignment (interbandMultipleTA) field and maximum multiple-timing alignment (maxMultipleTimingAdvance) field included in the RF parameters field as in Table 4.

TABLE 4
RF-Parameters ::= SEQUENCE {

| | |
|---|---|
| supportedBandCombination | SupportedBandCombination-r10 |
| interbandMultipleTA | MultipleTA |
| maxMultipleTimingAdvance | INTEGER (1...4) |

OPTIONAL,
}

Referring to Table 4, the multiple-timing alignment capability information includes an interbandMultipleTA field and a maxMultipleTimingAdvance field. The interbandMultipleTA field and the maxMultipleTimingAdvance field are selectively included in the RF-Parameters field that is an upper field. The interbandMultipleTA field and the maxMultipleTimingAdvance field being included in the RF-Parameters field indicates that the user equipment supports up to 1-4 multiple-timing alignments. Integer(1 . . . 4) is merely an example, and the maximum number of multiple-timing alignments supportable may be four or more or less. The interbandMultipleTA field and the maxMultipleTimingAdvance field being not included in the RF-Parameters field indicates that the user equipment does not support multiple-timing alignment.

As another example, in the inter-band carrier aggregation-supportive user equipment, whether multiple-timing alignment is supported may be implicitly signaled. By using information regarding a simultaneously supported (or aggregated) band, although the user equipment does not explicitly indicate whether the user equipment supports multiple-timing alignment, the base station may estimate multiple-timing alignment capability of the user equipment. The user equipment simultaneously being able to support means that in the corresponding combination of bands, the user equipment may perform downlink reception at the same time or uplink transmission at the same time. The user equipment may display a band combination that is simultaneously supported as a field of a hierarchical structure. Total supported band combinations (supportedBandCombination) are first indicated, a band (BandCombinationParameter) included in each band combination is indicated next, and the characteristics of bands included in each combination are finally indicated.

For example, assume that band combinations simultaneously supported by the user equipment are {band 1}, {band1, band2}, and {band 1, band2, band 3}. The three band combinations supported by the user equipment are each specified by these band combination parameters (BandCombinationParameter) fields in the supported band combination (supportedBandCombination) field. The maximum number of supported band combinations, maxBandComb, may be, e.g., 128. That is, a maximum of 128 band combination parameters (BandCombinationParameter) fields may be included in the supported band combination (supportedBandCombination) field.

The first band combination {band 1} has one band and is indicated by the first band combination parameter (BandCombinationParameter) field. The second band combination is {band 1, band 2} with two bands and is indicated by the second band combination parameter (BandCombinationParameter) field. The third band combination is {band 1, band 2, band 3} with three bands and is indicated by the third band combination parameter (BandCombinationParameter) field.

That is, as many band combination parameter (BandCombinationParameter) fields as the number of supported band combinations exist and are inserted as subfields of the supported band combination fields. The bands included in each band combination are a combination of bands simultaneously supported by the user equipment and the maximum value thereof, maxSimultaneousBands, may be, e.g., 64.

Next, specific physical characteristics of bands such as the indexes of bands included in each band combination, component carrier class (CA class), or MIMO capability are defined by a band parameters field that is a subfield of the band combination parameter (BandCombinationParameter) field. The index of a band is indicated by the bandEUTRA field, and the indicated values have a range of 1 to 64. For example, the indexes of the bands are represented in the following table:

TABLE 5

| E-UTRA | | |
|---|---|---|
| operating | UL operating band | DL operating band |
| band | (F_{UL}_{_{—}}_{Low}-F_{UL}_{_{—}}_{High}) | (F_{DL}_{_{—}}_{Low}-F_{DL}_{_{—}}_{High}) |
| 1 | 1920 MHz-1980 MHz | 2110 MHz-2170 MHz |
| 2 | 1850 MHz-1910 MHz | 1930 MHz-1990 MHz |
| 3 | 1710 MHz-1785 MHz | 1805 MHz-1880 MHz |
| 4 | 1710 MHz-1755 MHz | 2110 MHz-2155 MHz |
| 5 | 824 Hz-849 MHz | 869 MHz-894 MHz |
| 6 | 830 MHz-840 MHz | 875 MHz-885 MHz |
| 7 | 2500 MHz-2570 MHz | 2620 MHz-2690 MHz |
| 8 | 880 MHz-915 MHz | 925 MHz-960 MHz |
| 9 | 1749.9 MHz-1784.9 MHz | 1844.9 MHz-1879.9 MHz |
| 10 | 1710 MHz-1770 MHz | 2110 MHz-2170 MHz |
| 11 | 1427.9 MHz-1447.9 MHz | 1475.9 MHz-1495.9 MHz |
| 12 | 698 MHz-716 MHz | 728 MHz-746 MHz |
| 13 | 777 MHz-787 MHz | 746 MHz-756 MHz |
| 14 | 788 MHz-798 MHz | 758 MHz-768 MHz |
| 15 | Reserved | Reserved |
| 16 | Reserved | Reserved |
| 17 | 704 MHz-716 MHz | 734 MHz-746 MHz |
| 18 | 815 MHz-830 MHz | 860 MHz-875 MHz |
| 19 | 830 MHz-845 MHz | 875 MHz-890 MHz |
| 20 | 832 MHz-862 MHz | 791 MHz-821 MHz |
| 21 | 1447.9 MHz-1462.9 MHz | 1495.9 MHz-1510.9 MHz |
| . . . | . . . | . . . |
| 33 | 1900 MHz-1920 MHz | 1900 MHz-1920 MHz |
| 34 | 2010 MHz-2025 MHz | 2010 MHz-2025 MHz |
| 35 | 1850 MHz-1910 MHz | 1850 MHz-1910 MHz |
| 36 | 1930 MHz-1990 MHz | 1930 MHz-1990 MHz |
| 37 | 1910 MHz-1930 MHz | 1910 MHz-1930 MHz |
| 38 | 2570 MHz-2620 MHz | 2570 MHz-2620 MHz |
| 39 | 1880 MHz-1920 MHz | 1880 MHz-1920 MHz |
| 40 | 2300 MHz-2400 MHz | 2300 MHz-2400 MHz |
| 41 | 2496 MHz-2690 MHz | 2496 MHz-2690 MHz |
| 42 | 3400 MHz-3600 MHz | 3400 MHz-3600 MHz |
| 43 | 3600 MHz-3800 MHz | 3600 MHz-3800 MHz |

Referring to Table 5, in case bandEUTRA field=9, for example, the corresponding band is FDD, the uplink operating band is 1749.9 MHz-1784.9 MHz, and the downlink operating band is 1844.9 MHz-1879.9 MHz. As such, each band is divided into a band used for uplink and a band used for downlink, and per-link characteristics are indicated again by an uplink band parameters (bandParametersUL) field that is a subfield of the band parameters field and a downlink band parameters (bandParametersDL) field.

The uplink band parameters field includes, as subfields, a component carrier class (ca-BandwidthClassUL) field and an MIMO capability (supportedMIMO-CapabilityUL) field. The component carrier class field defines a component carrier class for each of simultaneously aggregated bands. For example, the component carrier classes may be classified into A to F as in the following table, and transmit bandwidth configuration aggregated per component carrier class, maximum number of CCs and protection bandwidth are defined.

TABLE 6

| Component | Aggregated | Maximum | Protection bandwidth |
|---|---|---|---|
| carrier | transmit bandwidth | number of | (Nominal Guard Band) |
| class | configuration | CCs | BW_{GB} |
| A | N_{RB, agg} ≦ 100 | 1 | 0.05 BW_{Channel(1)} |
| B | N_{RB, agg} ≦ 100 | 2 | Not defined |
| C | 100 < N_{RB, agg} ≦ 200 | 2 | 0.05 |
| | | | max(BW_{Channel(1)}, |
| | | | BW_{Channel(2)}) |
| D | 200 < N_{RB, agg} ≦ 300 | 3 | Not defined |
| E | 300 < N_{RB, agg} ≦ 400 | 4 | Not defined |
| F | 400 < N_{RB, agg} ≦ 500 | 5 | Not defined |

Referring to Table 6, in the case of component carrier class A, the maximum number of CCs configurable in the corresponding band is 1, and thus, carrier aggregation is not made in the corresponding band. And, the transmit bandwidth aggregated by a maximum of one CC is configured by a maximum of 100 or less resource blocks (RBs) (N_{RB,agg}≦100). In the case of component carrier class B, the maximum number of CCs in the corresponding band is 2, and thus, aggregation may be done by up to two CCs in the corresponding band. Further, since N_{RB,agg}≦100, the transmit bandwidth aggregated by up to two CCs is configured by a maximum of 100 or less resource blocks. Meanwhile, BW_{channel(1)} and BW_{channel(2)} mean channel bandwidths of two E-UTRA component carriers in accordance with the following table.

TABLE 7

| | | | | | | |
|---|---|---|---|---|---|---|
| Channel bandwidth | 1.4 | 3 | 5 | 10 | 15 | 20 |
| BW_{Channel} [MHz] | | | | | | |
| Configuration of | 6 | 15 | 25 | 50 | 75 | 100 |
| transmit bandwidth | | | | | | |
| N_{RB} | | | | | | |

Referring to Table 7, types of bandwidths of uplink or downlink component carriers of each serving cell as used in the LTE system are shown.

In sum, the information regarding band combinations supported for the user equipment includes band combination (supportedBandCombination) field, band combination parameter (BandCombinationParameter) field, band parameters field, uplink band parameters (bandParametersUL), component carrier class (ca-BandwidthClassUL) field, MIMO and capability (supportedMIMO-CapabilityUL) field, and all such fields are shown in Table 8 below. The supported band combination (supportedBandCombination) field is included in the RF-parameters field.

TABLE 8
RF-Parameters ::= SEQUENCE {

| | |
|---|---|
| supportedBandCombination | SupportedBandCombination |

}
SupportedBandCombination ::= SEQUENCE (SIZE (1..maxBandComb )) OF
BandCombinationParameters
BandCombinationParameters ::= SEQUENCE (SIZE (1..maxSimultaneousBands )) OF
BandParameters
BandParameters ::= SEQUENCE {

| bandEUTRA | INTEGER (1..64), | |
|---|---|---|
| bandParametersUL | BandParametersUL | OPTIONAL, |
| bandParametersDL | BandParametersDL | OPTIONAL |

}

BandParametersUL ::= SEQUENCE (SIZE (1..maxBandwidthClass )) OF CA-MIMO-

ParametersUL

CA-MIMO-ParametersUL ::= SEQUENCE {

| | | |
|---|---|---|
| ca-BandwidthClassUL | CA-BandwidthClass , | |
| supportedMIMO-CapabilityUL | MIMO-CapabilityUL | OPTIONAL |

For example, assume that there are three band combinations and that each band combination consists of band 1 and band 2. In such case, the supported band combination (supportedBandCombination) field includes three band combination parameter (BandCombinationParameter) fields. Meanwhile, since each band combination consists of two bands, each band combination parameter field includes two band parameters (BandParameters) field. The two band parameters fields each include bandEUTRA fields indicating band 1 and band 2, respectively.

In such circumstance, component carrier classes that may be possessed by the two bands may be involved in three scenarios as shown in the following table:

TABLE 9

| Band | | |
|---|---|---|
| combination 1~3 | Band 1 | Band 2 |
| scenario 1 | downlink: CA Class ‘A’, | downlink: CA Class ‘A’, |
| | MIMO enable | MIMO enable |
| | uplink: CA Class ‘A’, | uplink: CA Class ‘A’, |
| | MIMO enable | MIMO enable |
| scenario 2 | downlink: CA Class ‘A’, | downlink: CA Class ‘A’, |
| | MIMO enable | MIMO enable |
| | uplink: CA Class ‘x’, | uplink: CA Class ‘A’, |
| | MIMO enable | MIMO enable |
| scenario 3 | downlink: CA Class ‘y’, | downlink: CA Class ‘y”, |
| | MIMO enable | MIMO enable |
| | uplink: CA Class ‘z’, | uplink: CA Class ‘z”, |
| | MIMO enable | MIMO enable |

Referring to Table 9, scenario 1 involves when the uplink component carrier classes of band 1 and band 2 are both ‘A.’ In such case, the ca-BandwidthClassUL field corresponding to band 1 and the ca-BandwidthClassUL field corresponding to band 2 all indicate ‘A.’ The component carrier class (CA Class) A means that only a single component carrier in the band is supported. Accordingly, the band itself means non-CA but one component carrier is supported for each of band 1 and band 3. Conclusively, two component carriers are supported in light of the user equipment. Thus, scenario 1 means that inter-band carrier aggregation is possible and carrier aggregation may be done using band 1 and band 3.

Scenario 2 involves when the uplink component carrier class of band 1 is ‘x,’ and the uplink component carrier class of band 3 is ‘A.’ x may be any one of B to F. That is, this is the case where only a single component carrier is supported in one band and aggregation of two or more component carriers are supported in another band. The ca-BandwidthClassUL field corresponding to band 1 indicates one of B to F, and the ca-BandwidthClassUL field corresponding to band 3 indicates ‘A.’ Accordingly, in light of band 3 alone, it means non-CA. However, since band 1 supports two or more component carriers, it, in light of user equipment, conclusively means that two or more component carriers are supported. Accordingly, scenario 2 means that inter-band carrier aggregation is possible and may do carrier aggregation using different bands, band 1 and band 3.

Scenario 3 involves when the uplink component carrier class of band 1 is ‘z,’ and the uplink component carrier class of band 3 is ‘z’.′ z and z′ may be any one of B to F. That is, this is the case where a plurality of component carriers are supported in both the two bands. The ca-BandwidthClassUL fields corresponding to band 1 and band 3 each indicate one of B to F. Since two or more component carriers are supported in both band 1 and band 3, it conclusively means, in light of the user equipment, that two or more component carriers are supported. Accordingly, scenario 3 means that inter-band carrier aggregation is possible, carrier aggregation using band 1 and band 3 different from each other may be done.

Although the description of the scenario shown in Table 9 focuses on the uplink carrier aggregation, for example, the same may also apply to downlink carrier aggregation.

The user equipment may implicitly inform the base station of whether multiple-timing alignment may be supported through information regarding band combinations supported for the user equipment and specific determination thereon may be made as follows.

The user equipment being able to perform inter-band carrier aggregation indicates that the user equipment may support multiple-timing alignment. That is, in case there are at least two or more uplink bands with the component carrier class set as ‘A’ or higher in one band combination, this may mean that multiple-timing alignment is supported, as well as that carrier aggregation is done between the corresponding bands. Although the user equipment does not explicitly indicate supporting multiple-timing alignment, the base station may be implicitly aware of whether to support multiple-timing alignment from information regarding band combinations supported for the user equipment. Since uplink parameters and downlink parameters for each band are optional and thus may not exist, the base station may be aware of whether to support multiple-timing alignment even without changing the existing fields.

As such, by using the information on the supported band combinations for purposes of inter-band carrier aggregation, the user equipment need not provide multiple-timing alignment capability information in inter-band carrier aggregation to the base station through separate signaling, thus reducing resources necessary for signaling.

(2) Configuration of Intra-Band Carrier Aggregation and Multiple-Timing Alignment Capability Information

Also in case intra-band carrier aggregation is done, a method is needed for the user equipment to inform whether to support multiple-timing alignment capability. Support of the multiple-timing alignment capability may be defined per band. Accordingly, if there is an upper field that defines per-band characteristics, the multiple-timing alignment capability information may be included in the upper field as a subfield. Various upper fields may exist. Hereinafter, several embodiments are disclosed for configuring multiple-timing alignment capability information depending on the type of upper field.

(2-1) In Case Upper Field is Intra-Band Uplink Non-Contiguous CA (nonContiguousUL-CA-WithinBand) Field

As an example, in case the user equipment supports carrier aggregation between component carriers non-contiguous to each other in the band, it may be seen that the user equipment supports multiple-timing alignment. Accordingly, by the intra-band uplink non-contiguous CA (nonContiguousUL-CA-WithinBand) field as shown in the following table, which indicates whether the user equipment supports carrier aggregation between component carriers non-contiguous to each other in the band, the user equipment's multiple-timing alignment capability may be implicitly signaled. That is, if there are bands (or frequency bands) in which multiple-timing alignment is supported, these may be represented in the list shown in the following table.

TABLE 10

| nonContiguousUL-CA-WithinBand-List ::= SEQUENCE (SIZE | |
|---|---|
| (1..maxBands)) OF nonContiguousUL-CA-WithinBand | |
| nonContiguousUL-CA-WithinBand ::= | SEQUENCE { |
| bandEUTRA | INTEGER (1..64), |
| } | |

Referring to Table 10, the intra-uplink non-contiguous CA list (nonContiguousUL-CA-WithinBand-List) field indicates a band supporting uplink non-contiguous carrier aggregation in the band. The nonContiguousUL-CA-WithinBand-List field includes the intra-uplink non-contiguous CA list (nonContiguousUL-CA-WithinBand-List) field that is a subfield, and as many nonContiguousUL-CA-WithinBand-List fields as a maximum of maxBand may be included. maxBands may be, e.g., 64. Each nonContiguousUL-CA-WithinBand-List field includes a bandEUTRA field indicating a band supporting the uplink non-is contiguous CA. The band indicated by bandEUTRA may do uplink non-contiguous CA, and thus, it may be seen that in this band the user equipment supports multiple-timing alignment.

As another example, each nonContiguousUL-CA-WithinBand field may further include a bandEUTRA field and a multiple-timing alignment (MTA) field indicating whether to explicitly support multiple-timing alignment in the corresponding band as shown in Table 11:

TABLE 11
nonContiguousUL-CA-WithinBand-List ::= SEQUENCE (SIZE
(1..maxBands)) OF nonContiguousUL-CA-WithinBand

| | |
|---|---|
| nonContiguousUL-CA-WithinBand ::= | SEQUENCE { |
| bandEUTRA | INTEGER (1..64), |
| MTA | ENUMERATED {supported} |
| OPTIONAL, | |
| } | |

Referring to Table 11, the bandEUTRA field indicates that the corresponding band supports inter-band uplink non-contiguous CA, and the MTA field indicates, separately from the bandEUTRA field, whether the corresponding band supports multiple-timing alignment.

Here, the intra-uplink non-contiguous CA list (nonContiguousUL-CA-WithinBand-List) field as shown in Table 10 or Table 11, together with the rf-Parameters field or phyLayerParameters field of the user equipment, may be fields equivalently included in the E-UTRA capability (UE-EUTRA-Capability) field of the user equipment. Or, the intra-uplink non-contiguous CA list (nonContiguousUL-CA-WithinBand-List) field as shown in Table 10 or Table 11 may be a subfield that is included in the rf-Parameters field or phyLayerParameters field of the user equipment as shown in Table 12.

TABLE 12

| | |
|---|---|
| RF-Parameters ::= | SEQUENCE { |
| supportedBandCombination | SupportedBandCombination |
| nonContiguousUL-CA-WithinBand-List | nonContiguousUL-CA- |

WithinBand-List
}
nonContiguousUL-CA-WithinBand-List ::= SEQUENCE (SIZE
(1..maxBands)) OF nonContiguousUL-CA-WithinBand

| | |
|---|---|
| nonContiguousUL-CA-WithinBand ::= | SEQUENCE { |
| bandEUTRA | INTEGER (1..64), |
| MTA | ENUMERATED {supported} |
| OPTIONAL, | |
| } | |

(2-2) In Case Upper Field is Uplink Band Parameters Field

Information regarding band combinations simultaneously supported by the user equipment, in light of the hierarchical structure shown in Table 8, includes a CA-MIMO-ParametersUL field that is a sort of uplink band parameters field. The CA-MIMO-ParametersUL field includes a ca-BandwidthClassUL field defining the component carrier class of a band, and thus, the multiple-timing alignment capability information may be a subfield included in the upper field, CA-MIMO-ParametersUL field. This is represented in the following table:

TABLE 13
CA-MIMO-ParametersUL ::= SEQUENCE {

| ca-BandwidthClassUL | CA-BandwidthClass-r10, | |
|---|---|---|
| supportedMIMO- | MIMO-Capability | OPTIONAL, |
| CapabilityUL | UL-r10 | |
| intrabandMultipleTA | MultipleTA | OPTIONAL, |

}
CA-BandwidthClass ::= ENUMERATED {a, b, c, d, e, f, ...}
MIMO-CapabilityUL ::= ENUMERATED {twoLayers, fourLayers}
MultipleTA ::= ENUMERATED {supported}

Referring to Table 13, the CA-MIMO-ParametersUL field selectively includes an intrabandMultipleTA field that is multiple-timing alignment capability information. If the interbandMultipleTA field is included in the CA-MIMO-ParametersUL field, this indicates that the corresponding band supports the intra-band multiple-timing alignment. That is, it indicates that multiple time alignment values may be configured in the corresponding band. In contrast, if the interbandMultipleTA field is not included in the CA-MIMO-ParametersUL field, this indicates that the corresponding band does not support intra-multiple-timing alignment. Here, the corresponding band is indicated by the bandEUTRA field in the BandParameters field.

(2-3) In Case Upper Field is Supported Band EUTRA (supportedBandEUTRA) Field Supported for User Equipment

The supported band EUTRA (supportedBandEUTRA) field indicates information regarding all bands indicated by the band combination parameter. This is as shown in the following table:

TABLE 14

| | |
|---|---|
| RF-Parameters ::= | SEQUENCE { |
| supportedBandListEUTRA | SupportedBandListEUTRA |

}

| | |
|---|---|
| SupportedBandListEUTRA ::= | SEQUENCE (SIZE (1..maxBands)) OF |
| SupportedBandEUTRA | |
| SupportedBandEUTRA ::= | SEQUENCE { |
| bandEUTRA | INTEGER (1..64), |
| halfDuplex | BOOLEAN |

}

Referring to Table 14, the supported band list EUTRA (supportedBandListEUTRA) field is a subband of the RF-parameters field. The supported band EUTRA (supportedBandEUTRA) field is a subband of the supported band list EUTRA (supportedBandListEUTRA) field. The supported band EUTRA (supportedBandEUTRA) field includes a bandEUTRA field indicating an index of an operating band in the corresponding band and a halfDuplex field indicating whether the corresponding band supports a half-duplex mode. If the halfDuplex field value is ‘true,’ only half-duplex operation is supported for the corresponding band, and if the halfDuplex field value is ‘false,’ full-duplex operation is supported for the corresponding band.

Situations in which the user equipment needs to support multiple-timing alignment may be summarized as follows. In accordance with network configuration, there is an environment in which multiple-timing alignment needs to be supported. In the case of inter-band carrier aggregation for uplink, even when the user equipment carries the same signal over a plurality of aggregated uplink component carriers, time that the signal of the main path having the strongest energy may differ from component carrier to component carrier due to signal propagation characteristics for different frequencies. Accordingly, the network or base station may determine that different timing alignment values may be set for uplink component carriers potentially configured between bands.

However, in the case of intra-band carrier aggregation, although the user equipment may actually support multiple-timing alignment, the situation where the network may request multiple-timing alignment is when some frequency bands in the band are in service only through a remote radio head (RRH) or relay. The relay is designed to relay radio signals only in the frequency band that is being serviced by the service provider. This is why wired relays are not capable of relaying on the other frequency bands. Further, an interference cancellation system (ICS) relay, which is a representative radio relay, may cause unintentional results in signals that may exist in the frequency band when the ICS relay relays frequency bands other than the frequency band currently being in service by the network service provider. Accordingly, the wireless relay is set to relay radio signals limited to the frequency band currently being in service.

Meanwhile, network service providers' licensed frequency bands may not be always set to be the same as operating bands defined in the standards, and there may be the way in which some frequency bands only are relayed in the licensed frequency band, i.e., the case where one base station configures a plurality of frequency allocations (FA) in the same band but relays some of the Fas. Or, there may be an area where relays are installed and another area where no relay is installed among service areas. Accordingly, a situation may occur where the relaying operation for intra-carrier aggregation in the network may not be applicable to the entire frequency band. Accordingly, multiple-timing alignment may be required by the network upon uplink intra-band carrier aggregation.

In case the user equipment supports multiple-timing alignment and supports both FDD mode and TDD mode, the multiple-timing alignment is considered always supported in FDD. For example, the full duplex such as FDD may be designed for the user equipment to support multiple-timing alignment without any problem even when partial overlapping occurs between subframes due to the multiple-timing alignment. However, TDD may be different in frequency band from FDD, and upon TDD operation, no multiple-timing alignment may be structurally supported. For example, in half-duplex such as TDD, partial overlapping between subframes transmitted through different serving cells, which is caused by the multiple-timing alignment, may continuously occur as partial overlapping of uplink/downlink, and thus, if the user equipment cannot address such problems, for example, if the user equipment supports half duplex alone, the user equipment may not support multiple-timing alignment.

Meanwhile, since FDD and TDD respectively have different band combinations supporting carrier aggregation, whether multiple-timing alignment is supported is different for each of FDD and TDD. However, if FDD/TDD band combinations all may be represented by single signaling, multiple-timing alignment information may be transmitted as single information. That is, in the case of using band combination signal configuration encompassing both FDD and TDD, information on FDD and TDD may be fully transmitted by single signaling.

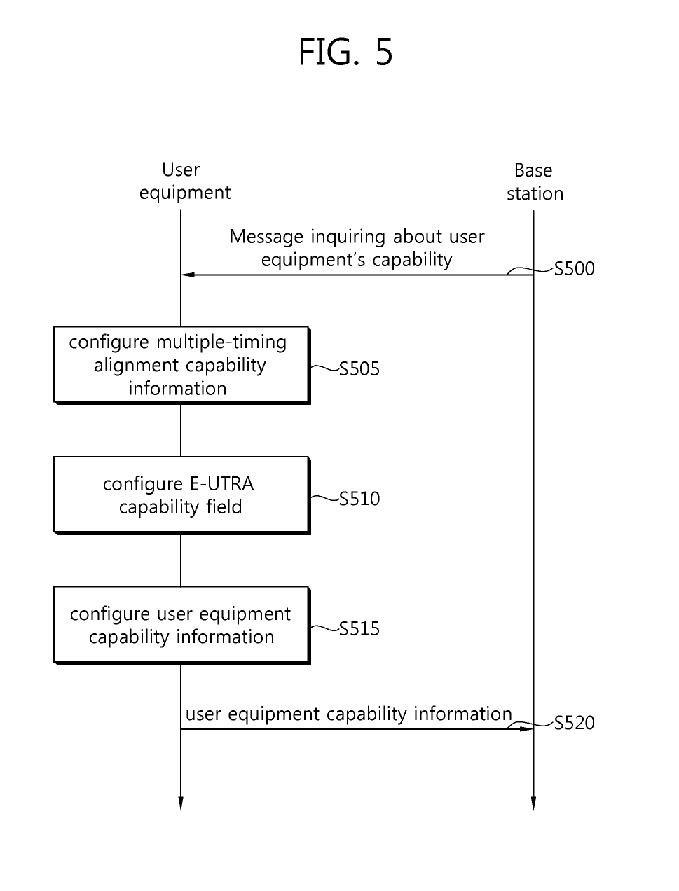

FIG. 5 is a flowchart illustrating a signaling procedure regarding multiple-timing alignment capability according to an embodiment of the present invention. This is regarding a procedure of transmitting user equipment's capability.

Referring to FIG. 5, the radio access network or base station transmits a UE capability inquiry message to the user equipment (S500). For example, the radio access network includes a UTRAN (universal terrestrial radio access network) following 3GPP standards. The user equipment may be in the radio connected state. The radio access network may initiate user equipment capability procedure when user equipment capability information is needed. The UE capability inquiry message includes a UE capability request field. The UE capability request field requests a list of radio access networks supportable by the user equipment. For example, the UE capability request field may include any one of E-UTRA, UTRA, GERAN-CS, GERAN-PS, and CDMA2000. In case the UE capability request field includes E-UTRA, the user equipment may set the radio access network type field as E-UTRA.

The user equipment configures multiple-timing alignment capability information (S505). As methods of configuring multiple-timing alignment capability information, as described above, there may be a method of configuring the information on a per-user equipment basis and a method of configuring the information on a per-band basis.

The user equipment configures the user equipment's E-UTRA capability (UE-EUTRA-Capability) field including the above configured multiple-timing alignment capability information (S510). The user equipment's E-UTRA capability field is used to convey radio access capability parameters for E-UTRA.

As a field inserted in the syntax structure of the user equipment's E-UTRA is capability (UE-EUTRA-Capability) field for further expansion, an information element (IE), nonCriticalExtension, is present. Multiple-timing alignment capability information is added to the user equipment's E-UTRA capability (UE-EUTRA-Capability) field as follows, and the user equipment's E-UTRA capability (UE-EUTRA-Capability) field may be expanded.

TABLE 15

| | |
|---|---|
| UE-EUTRA-Capability-v1060-IEs ::= | SEQUENCE { |
| nonCriticalExtension | UE-EUTRA-Capability-v1100-IEs |

OPTIONAL,
}

Referring to Table 15, it means that UE-EUTRA-Capability-v1100-IEs is included in the structure of UE-EUTRA-Capability-v1060-IEs.

If there is no added field, the user equipment's E-UTRA capability (UE-EUTRA-Capability) field is written in the syntax having the format shown in the following table.

TABLE 16

| | |
|---|---|
| UE-EUTRA-Capability-v1020-IEs ::= | SEQUENCE { |
| nonCriticalExtension | SEQUENCE{ } |

OPTIONAL,
}

Or, the user equipment's E-UTRA capability (UE-EUTRA-Capability) field may be configured as follows.

TABLE 17

| UE-EUTRA-Capability-v1100-IEs ::= | SEQUENCE { | |
|---|---|---|
| rf-Parameters-v1100 | RF-Parameters-v1100 | OPTIONAL, |
| nonCriticalExtension | SEQUENCE { } | OPTIONAL |
| } | | |

Referring to Table 17, rf-Parameters-v1100 is a field for a new RF parameter including multiple-timing alignment capability information, and nonCriticalExtension is a field preparing for the case where there will be a new field to be added in the future. rf-Parameters-v1100 is configured in the syntax as follow.

TABLE 18

| | |
|---|---|
| RF-Parameters-v1100 ::= | SEQUENCE { |
| supportedBandCombinationExt | SupportedBandCombinationExt |

}
SupportedBandCombinationExt ::=SEQUENCE (SIZE
(1..maxBandComb)) OF MTA-Capability
MTA-Capability ::= SEQUENCE {
mTA-capability BOOLEAN,

| | | |
|---|---|---|
| nonCriticalExtension | SEQUENCE{ } | OPTIONAL |

}

Referring to Table 18, the supportedBandCombinationExt field is a list of individually corresponding entries having the same order as band combinations listed by the supported band combination (supportedBandCombination) field. For example, there are entries of the supportedBandCombinationExt field as the number of supported band combinations, and the first entry corresponds to the first band combination, the second entry corresponds to the second band combination.

In the example shown in Table 18, each entry includes multiple-timing alignment capability information (MTA-capability) of the corresponding band combination. That is, whether multiple-timing alignment is supported per band combination is individually defined by each entry.

For example, assume that the total number of supported band combinations (supportedBandCombination) is three and the band combinations, respectively, are {band3, band5}, {band1, band5}, {band5, band5}. In such case, the supportedBandCombinationExt field includes three entries, and the first to third entries are listed in the following order. That is, the first entry corresponds to a combination of band 3 and band 5, the second entry corresponds to a combination of band 1 and band 5, and the third entry corresponds to a combination of band 5 and 5.

The first information (mTA-capability) of the MTA-capability field defined in the syntax of the supportedBandCombinationExt field may indicate whether to support MTA regarding the corresponding band combination in various forms.

As an example, mTA-capability may indicate whether to support MTA by a Boolean operation as shown in Table 18. For example, in case mTA-capability is ‘true,’ it indicates that the corresponding user equipment may support MTA in a combination of band 3 and band 5. In contrast, in case the first information (mTA-capability) of the MTA-capability field is ‘false,’ it indicates that the corresponding user equipment may not support MTA in a combination of band 3 and band 5.

As another example, mTA-capability may indicate whether to support MTA in the ENUMERATED form (i.e., ‘supported’ syntax). For example, ‘supported’ field being present (or mTA-capability field existing) indicates that the corresponding user equipment supports MTA, and ‘supported’ field not being present (or mTA-capability field not existing) indicates that the user equipment does not support MTA.

MTA-Capability field containing or not containing ‘mTA-capability’ field is the same in meaning as the RF-parameter field containing or not containing the ‘mTA-capability’ field. This is why as shown in Table 18, the RF-parameter field includes the MTA-Capability field. Thus, in case the RF-parameter field includes the ‘mTA-capability’ field regarding a specific band combination, it indicates that the user equipment MTA for the specific band combination. Or, in case the RF-parameter field does not include the ‘mTA-capability’ field regarding the specific band combination, it indicates that the user equipment does not support MTA for the specific band combination.

As still another example, mTA-capability may indicate whether to support MTA in the INTEGER form. For example, INTEGER being 0 indicates that the corresponding user equipment does not support MTA, and INTEGER being 1 indicates that the user equipment supports MTA.

As yet still another example, mTA-capability may indicate whether to support MTA in the bitmap form. For example, the bitmap being 0 indicates that the corresponding user equipment does not support MTA, and the bitmap being 1 indicates that the user equipment supports MTA.

As yet still another example, mTA-capability may indicate whether to support MTA in the bit string form. For example, the bit string being 0 indicates that the corresponding user equipment does not support MTA, and the bit string being 1 indicates that the user equipment supports MTA.

The user equipment constitutes user equipment capability information including a UE-CapabilityRAT-Container field including an E-UTRA capability field (S515). The user equipment transmits the user equipment capability information to the base station (S520). The user equipment's capability inquiry message and the user equipment capability information both may be RRC messages generated in the RRC layer.

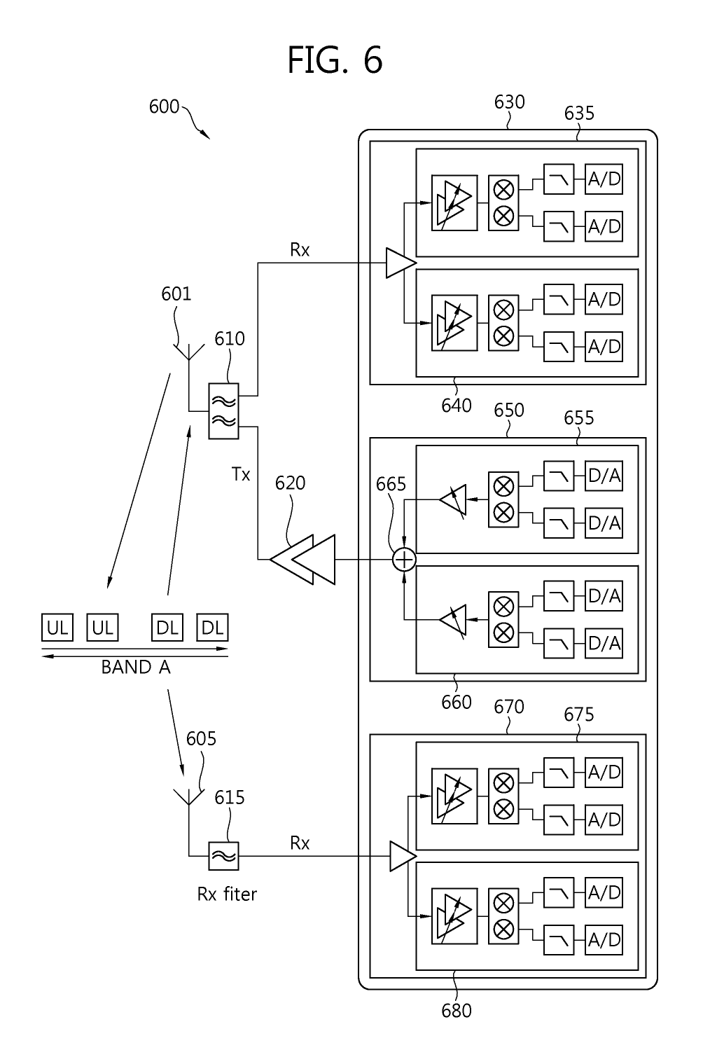

FIG. 6 is a view illustrating the structure of user equipment supporting multiple-timing alignment according to an embodiment of the present invention.

Referring to FIG. 6, the user equipment 600 includes a main antenna 601, a diversity antenna 605, a duplex filter 610, a Rx filter 615, a power amplifier 620, a first receiving unit 630, a first transmitting unit 650, and a second receiving unit 670.

The first transmitting unit 650 includes two transmitting modules 655 and 660, and each transmitting module 655 and 660 includes a base band processing unit, a band pass filter, and a digital/analog (D/A) converter. The first transmitting unit 650 combines signals for different uplink component carriers respectively generated from the two transmitting (tx) modules 655 and 660 into a single signal by a signal combiner 665 and inputs the single signal to the power amplifier 620.

In such case, undesired signals other than the original signals are highly likely to be generated, e.g., due to inter modulation distortion (IMD), which is the phenomenon that output frequency components come as sums or differences of harmonic frequencies of signals having different frequency bands in the band. Here, the harmonics refer to frequency components that are multiples of the frequency of the original signal. The IMD components serve as signals that distort the information included in the original signals, and thus, frequency combinations of original signals with high IMD components are difficult to send.

Further, since filtering needs to be done on two or more transmission signals at different positions, power of emission components may be elevated. To suppress this, the overall transmission power should be thus reduced to a large extent. In other words, a high maximum power reduction (MPR) value needs to be set.

For such reasons, in the structure of the first transmitting unit 650, carrier aggregation may be supported only on carrier aggregation band combinations that may set small IMD and MPR values. Accordingly, multiple-timing alignment may also be supported on CA band combinations that may support carrier aggregation. In other words, multiple-timing alignment may be supported on some CA band combinations.

The first receiving unit 630 includes two receiving modules 635 and 640 and the second receiving unit 670 includes two receiving modules 675 and 680. Each receiving module 635, 640, 675, and 680 includes a base band processing unit, a band pass filter, and an analog/digital (A/D converter).

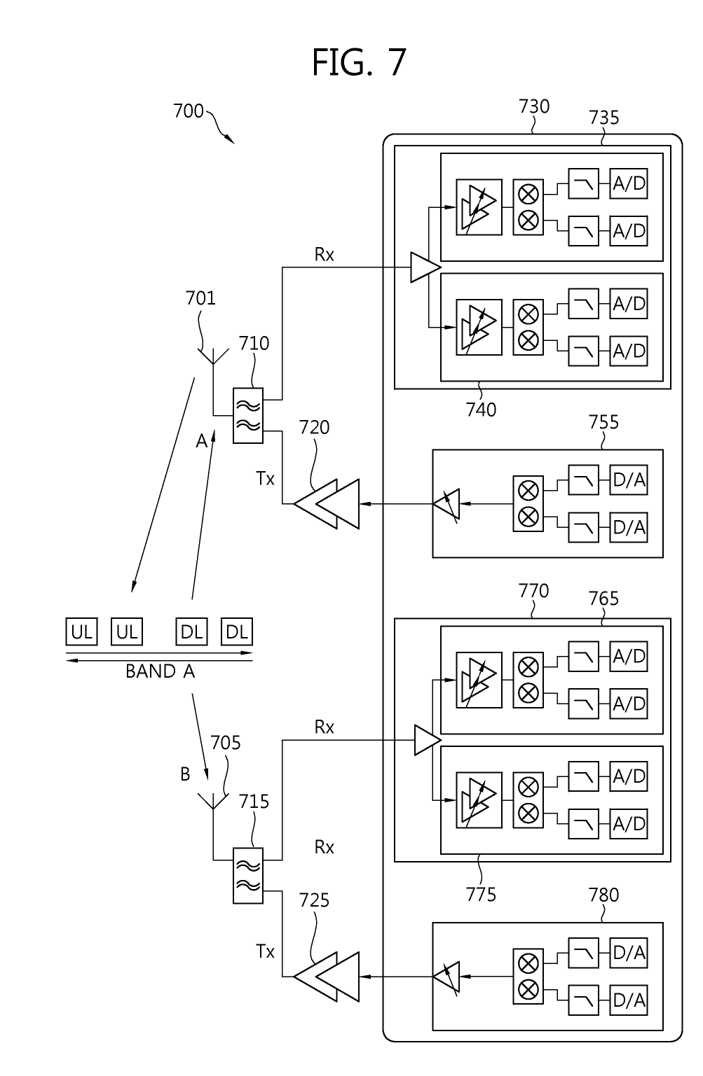

FIG. 7 is a view illustrating the structure of user equipment supporting multiple-timing alignment according to another embodiment of the present invention.

Referring to FIG. 7, the user equipment 700 includes a main antenna 701, a diversity antenna 705, duplex filters 710 and 715, power amplifiers 720 and 725, a first receiving unit 730, a first transmitting unit 755, a second receiving 770, and a second transmitting unit 780.

The first transmitting unit 755 and the second transmitting unit 780 each include a base band processing unit, a band pass filter, and a digital/analog (D/A) converter. The first and second transmitting units 755 and 80 each separate signals for different uplink component carriers from each other and enter it to the power amplifier 720 and 725 so that it may be transmitted through the antennas 701 and 705 split from each other. The first receiving unit 730 and the second receiving unit 770 each include two receiving modules 730 and 740 and 765 and 775 and each receiving module includes a base band processing unit, a band pass filter, and an analog/digital (A/D converter).

The user equipment 700 having such RF structure may support multiple-timing alignment on various band combinations or intra-band combinations for frequency bands supported by the receiving units 755 and 780.

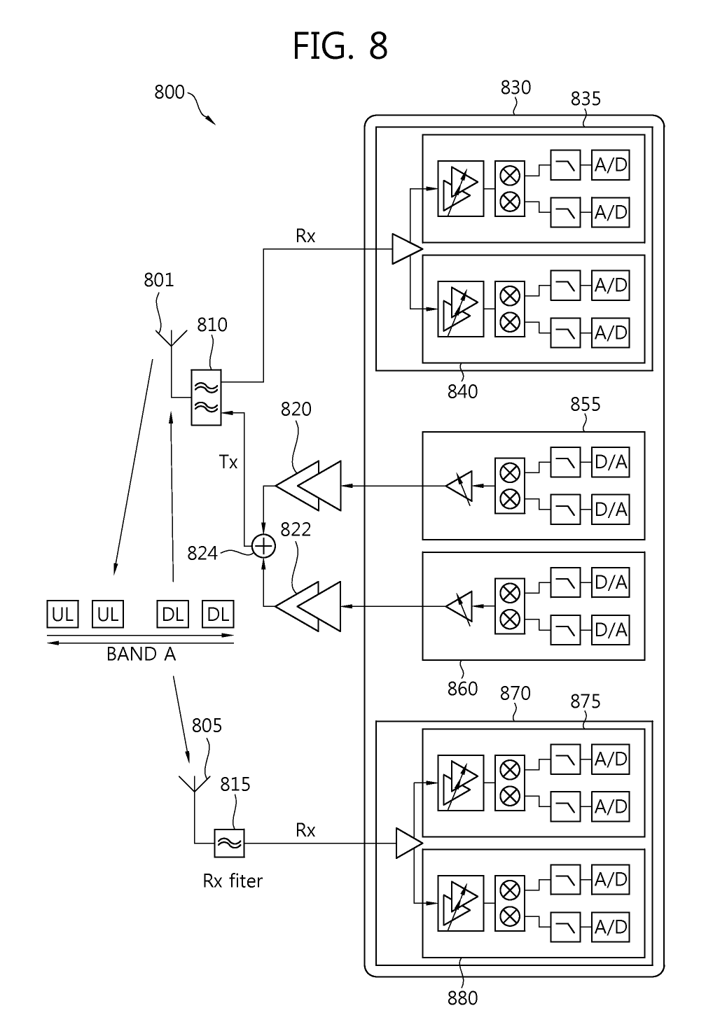

FIG. 8 is a view illustrating the structure of user equipment supporting multiple-timing alignment according to still another embodiment of the present invention.

Referring to FIG. 8, the user equipment 800 includes a main antenna 801, a diversity antenna 805, a duplex filter 810, a receiving filter 815, power amplifiers 820 and 822, a signal combiner 824, a first receiving unit 830, a first transmitting unit 855, a second transmitting unit 860, and a second receiving unit 870.

The first transmitting unit 855 and the second transmitting unit 860 each include a base band processing unit, a band pass filter, and a digital/analog (D/A) converter. Signals for different uplink component carriers generated respectively generated from the split two first and second transmitting units 855 and 860 are entered to the power amplifiers 820 and 822 split from each other and are transmitted through the same main antenna 801. The first receiving unit 830 and the second receiving antenna 870 each include two receiving modules 835 and 840 and 875 and 880, and each receiving module includes a base band processing unit, a band pass filter, and an analog/digital (A/D) converter.

The user equipment 800 having such structure may support multiple-timing alignment on many band combinations or intra-band combinations for frequency bands supported by the transmitting units 855 and 860. However, as compared with the user equipment 700 shown in FIG. 7, two signals should be combined and should be transmitted through the same main antenna 801. Thus, signals from each transmitting unit 855 and 860 should be set to be 3 dB lower output (or transmission power).

If it is identified based on the user equipment's capability information that the user equipment supports multiple-timing alignment, the base station may later perform a process of obtaining a multiple-timing alignment value with the user equipment. The process of obtaining the multiple-timing alignment value is described below.

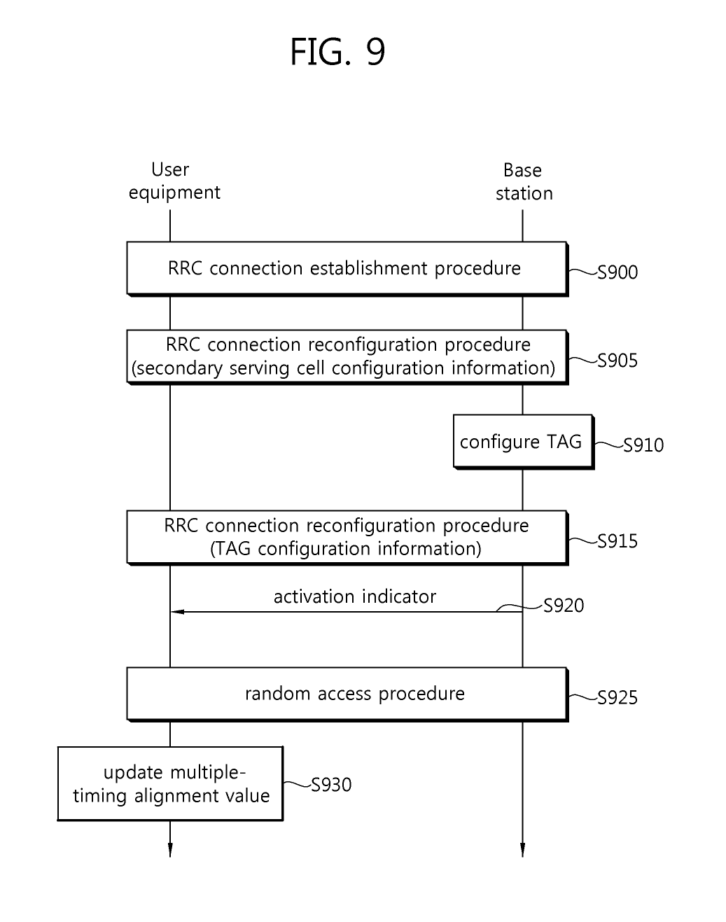

FIG. 9 is a flowchart illustrating a process of obtaining a multiple-timing alignment value according to an embodiment of the present invention.

Referring to FIG. 9, the user equipment and the base station perform an RRC connection establishment process on a selected cell (S900). The selected cell is a primary serving cell. The RRC connection establishment process includes processes of the base station transmitting an RRC connection establishment message to the user equipment and the user equipment transmitting an RRC connection establishment complete message to the base station.

The base station performs an RRC connection establishment process for additionally configuring one or more secondary serving cells for the user equipment (S905). Adding the secondary serving cells may be performed, e.g., in response to the user equipment's request or network's request or when more radio resources should be allocated to the user equipment as determined by the base station itself. Adding the secondary serving cell to the user equipment or deleting secondary serving cell from the user equipment may be instructed by an RRC connection reconfiguration message. The RRC connection reconfiguration process includes the process of the base station transmitting the RRC connection reconfiguration message to the user equipment and the user equipment transmitting an RRC reconfiguration complete message to the base station.

The base station configures TAG for the serving cells added to the user equipment (S910). Depending on the situation of carrier aggregation, inter-serving cell TAG configuration may be made cell-specifically. For example, in case serving cells having a specific frequency band are always provided through FSR or remote radio head (RRH), serving cells having the frequency band serviced directly from the base station and the serving cells having the specific frequency with respect to all the user equipment in the service coverage of the base station may be configured to belong to different TAGs—without FSR or remote radio head, the serving cells might have been configured to have the same timing alignment value, but this is another issue.

The base station performs an RRC connection reconfiguration process for transmitting TAG configuration information to the user equipment (S915). The TAG configuration information may have a format in which each secondary serving cell has its TAG ID information. Specifically, the uplink configuration information of each secondary serving cell may include TAG ID information. Or, the TAG configuration information may have a format of mapping a serving cell index (ServCellIndex) allocated per serving cell or a secondary serving cell index (ScellIndex) allocated only to the secondary serving cells. For example, it may be configured so that pTAG={ServCellIndex=‘1’, ‘2’}, sTAG1={ServCellIndex=‘3’, ‘4’} or pTAG={ScellIndex=‘1’, ‘2’}, sTAG1={SCellIndex=‘3’, ‘4’}. Since the primary serving cell has always a serving cell index of 0 and TAG ID=0, the primary serving cell has no configuration information. Further, secondary serving cells having no TAG ID information means that they are serving cells in pTAG or that they are serving cells in sTAG separate or independent from all the currently configured TAGs.

The base station, when attempting to perform scheduling on a secondary serving cell, transmits an activation indicator to the user equipment to activate the specific secondary serving cell (S920).

In case the user equipment fails to secure uplink sync in at least one sTAG, the user equipment should obtain multiple-timing alignment values that need to be adjusted for the sTAG. This may be implemented by a random access procedure indicated by the base station (S925).

The random access procedure for the activated secondary serving cells in sTAG may be initiated by instruction of PDCCH transmitted by the base station. The secondary serving cells that may receive the PDCCH instruction may be limited to secondary serving cells including timing references designated in the sTAG and may be any RACH configured secondary serving cell or all RACH configured secondary serving cells.

The base station controls the user equipment for the user equipment not to proceed with two or more random access procedures at the same time. Simultaneously performing the random access procedures include when two or more random access procedures are simultaneously conducted, synced with each other and when the random access procedures are performed at the same time during part of the time that the random access procedures are in progress. For example, when the user equipment performs random access procedure through the primary serving cell, a random access procedure is initiated through the secondary serving cell (receiving PDCCH order) while the user equipment awaits a random access response message. Here, the time of awaiting the random access response message may or may not include a section where the random access response message may be re-transmitted by the user equipment.

In case the base station fails to secure information enough to map a specific secondary serving cell to a specific TAG even using assistant information (e.g., locational information, RSRP, RSRQ, etc.) received from the user equipment and/or information in the network as previously secured, the specific secondary serving cell is set as a new sTAG and the uplink timing alignment value is obtained through a random access procedure.

If the user equipment receives a random access response message from the base station, the user equipment determines that the random access procedure is successfully complete and updates the multiple-timing alignment value for each secondary serving cell (S930). The random access response message may be transmitted, included in an RAR MAC PDU (Protocol Data Unit) received in PDSCH indicated by PDCCH scrambled with an RA-RNTI (random access-radio network temporary identifier).

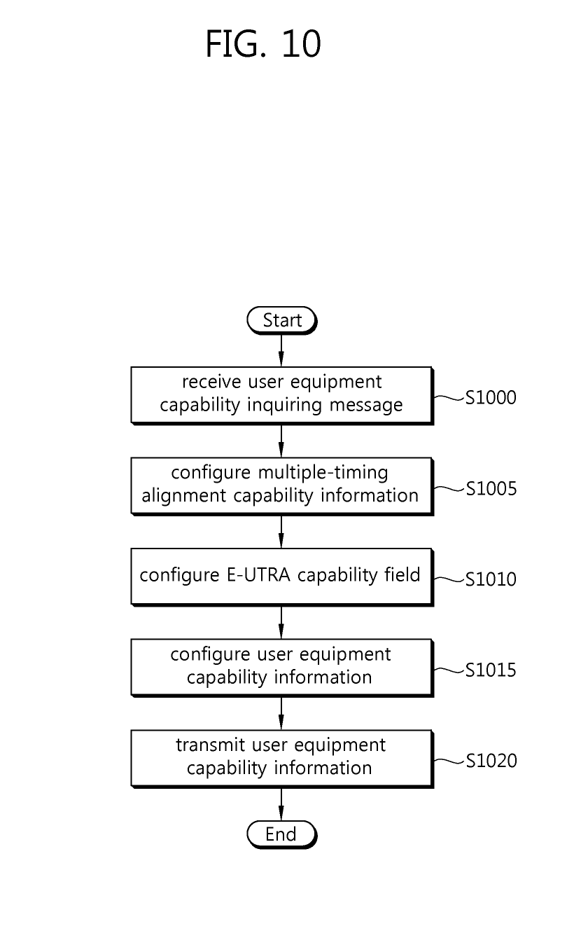

FIG. 10 is a flowchart illustrating a method of transmitting user equipment capability information by user equipment according to an embodiment of the present invention.

Referring to FIG. 10, the user equipment receives a UE capability inquiry message from the base station (S1000). The UE capability inquiry message includes a UE capability request field. The UE capability request field requests a list of random access networks supportable by the user equipment. For example, the UE capability request field may include any one of E-UTRA, UTRA, GERAN-CS, GERAN-PS, and CDMA2000.

In case the UE capability request field includes E-UTRA, the user equipment may configure the random access network type field as E-UTRA. The user equipment then configures multiple-timing alignment capability information (S 1005). As methods of configuring the multiple-timing alignment capability information by the user equipment, as described above, a method of configuring the information on a per-user equipment basis and a method of configuring the information on a per-band basis may be both included.

The user equipment configures a user equipment E-UTRA capability (UE-EUTRA-Capability) field including the above configured multiple-timing alignment capability information (S1010). The user equipment E-UTRA capability field is used to convey a random access capability parameter for E-UTRA.

The user equipment configures user equipment capability information including a UE-CapabilityRAT-Container field including the E-UTRA capability field (S 1015). The user equipment then transmits the configured user equipment capability information to the base station (S1020). Here, the user equipment capability inquiry message and the user equipment capability information both may be RRC message generated in the RRC layer.

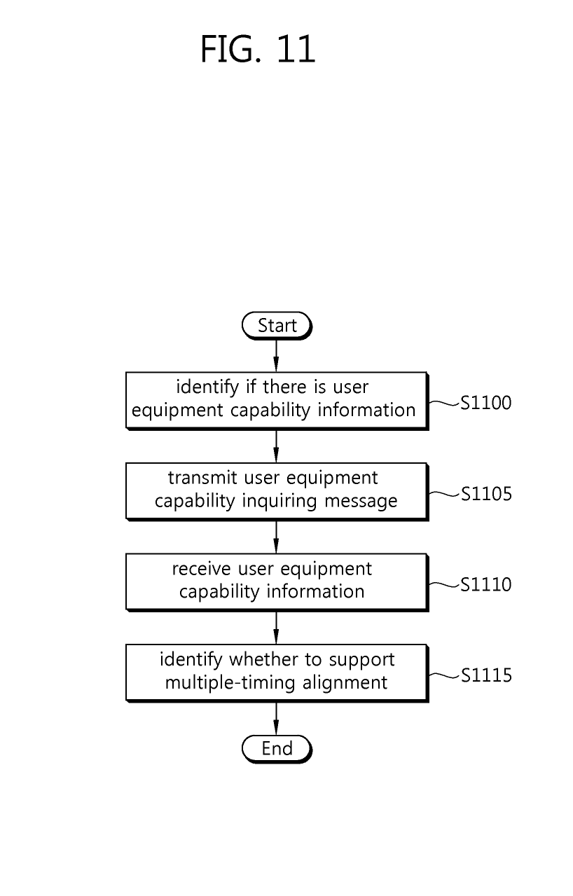

FIG. 11 is a flowchart illustrating a method of receiving user equipment capability information by a base station according to an embodiment of the present invention.

Referring to FIG. 11, the base station identifies whether there is user equipment capability information (S1100). If there is no user equipment capability information or user equipment capability information needs to be updated, the base station transmits a user equipment capability inquiry message to the user equipment (S1105). The user equipment capability inquiry message includes a user equipment capability request (UE capability request) field. The user equipment capability request field requests a list of random access networks supportable by the user equipment. For example, the user equipment capability request field may include any one of UTRA, UTRA, GERAN-CS, GERAN-PS, and CDMA2000.

In case the user equipment capability request field includes E-UTRA, the user equipment may configure the random access network type field as E-UTRA.

The base station receives user equipment capability information including multiple-timing alignment capability information from the user equipment (S1110). The base station then identifies whether the user equipment supports multiple-timing alignment based on the multiple-timing alignment capability information included in the user equipment capability information (S1115). If the user equipment supports multiple-timing alignment, the base station may perform multiple-timing alignment based on the procedure as shown in FIG. 9.

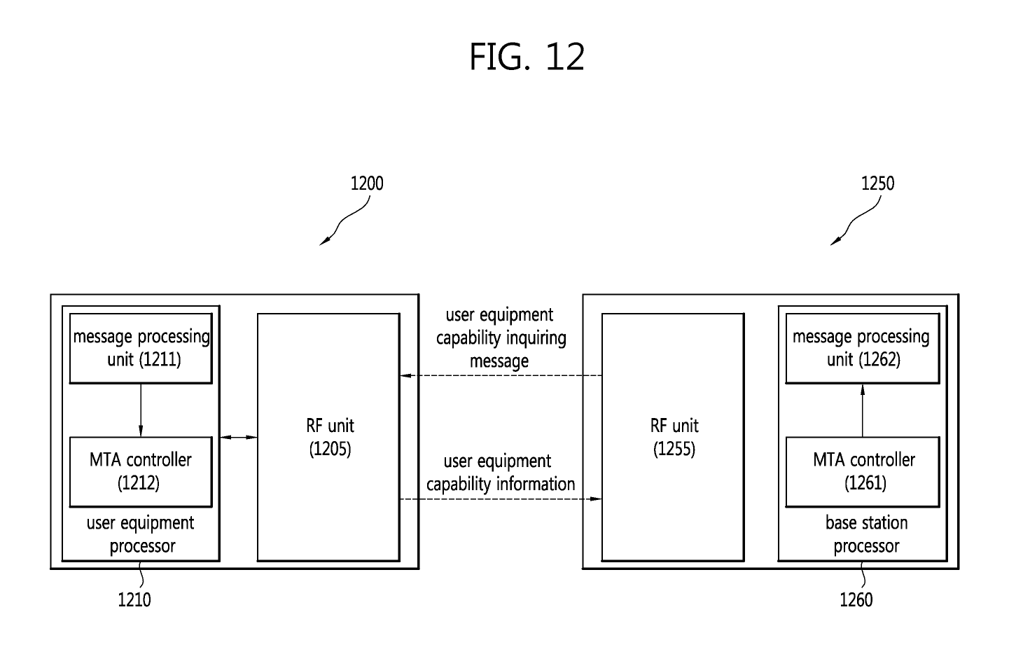

FIG. 12 is a block diagram illustrating user equipment and a base station transmitting and receiving user equipment capability information according to an embodiment of the present invention.

Referring to FIG. 12, the user equipment 1200 includes an RF unit 1205 and a user equipment processor 1210. Further, the user equipment processor 1210 includes a message processing unit 1211 and an MTA controller 1212.

The RF unit 1205 receives a user equipment capability inquiry message from the base station 1250. The user equipment capability inquiry message includes a user equipment capability request (UE capability request) field. The user equipment capability request field requests a list of random access networks supportable by the user equipment 1200. For example, the user equipment capability request field may include any one of E-UTRA, UTRA, GERAN-CS, GERAN-PS, and CDMA2000. The RF unit 1205 may have a transmitting unit and a receiving unit as shown in one of FIGS. 6 to 8.

The message processing unit 1211 identifies whether the capability request field of the user equipment 1200 includes E-UTRA. If the capability request field of the user equipment 1200 includes E-UTRA, the message processing unit 1211 configures the random access network type field as E-UTRA.

The message processing unit 1211 configures multiple-timing alignment capability information. The message processing unit 1211 determines whether the user equipment 1200 supports multiple-timing alignment based on characteristics of the RF unit 1205, and based on the determination, may optionally configure multiple-timing alignment capability information. For example, in case the user equipment 1200 supports multiple-timing alignment, as methods of configuring multiple-timing alignment capability information by the message processing unit 1211, a method of configuring the information on a per-user equipment basis and a method of configuring the information on a per-band basis may be both included as described above. Or, in case the user equipment 1200 does not support multiple-timing alignment, the message processing unit 1211 may not configure the multiple-timing alignment capability information.

The message processing unit 1211 configures a user equipment E-UTRA capability (UE-EUTRA-Capability) field including the above configured multiple-timing alignment capability information. The user equipment E-UTRA capability field is used to convey a random access capability parameter for E-UTRA.

The message processing unit 1211 configures user equipment capability information including a UE-CapabilityRAT-Container field including the E-UTRA capability field. The message processing unit 1211 may configure a user equipment capability inquiry message and user equipment capability information in the format of the RRC message generated in the RRC layer. The message processing unit 1211 sends the configured user equipment capability information to the RF unit 1205, and the RF unit 1205 transmits the user equipment capability information to the base station 1250.

In case the user equipment 1200 supports multiple-timing alignment, the MTA controller 1212 performs control so that multiple-timing alignment is conducted on at least one secondary serving cell or uplink component carrier configured in the user equipment 1200. For example, in case the user equipment 1200 fails to secure uplink sync in a plurality of serving cells configured in the user equipment 1200, the MTA controller 1212 performs a procedure of obtaining multiple-timing alignment values for the plurality of serving cells. At this time, the procedure of obtaining the multiple-timing alignment values may be implemented through a random access procedure as shown in FIG. 9.

The base station 1250 includes an RF unit 1255 and a base station processor 1260. The base station processor 1260 includes a message processing unit 1262 and an MTA controller 1261.

The RF unit 1255 transmits a user equipment capability inquiry message to the user equipment 1200 and receives user equipment capability information from the user equipment 1200.

The message processing unit 1262 identifies whether there is user equipment capability information of the user equipment 1200. If there is no user equipment capability information or user equipment capability information needs to be updated, the message processing unit 1262 generates a user equipment capability inquiry message and sends it to the RF unit 1255.

If the RF unit 1255 receives user equipment capability information including multiple-timing alignment capability information from the user equipment 1200, the message processing unit 1262 identifies whether the user equipment 1200 supports multiple-timing alignment based on the multiple-timing alignment capability information included in the user equipment capability information. If it is identified that the user equipment 1200 supports multiple-timing alignment, the MTA controller 1261 may perform multiple-timing alignment based on the procedure as shown in FIG. 9.

In the multiple component carrier system, a protocol of signaling multiple-timing alignment capability of the user equipment may become clear, and the multiple-timing alignment capability may be implicitly informed using parameters regarding carrier aggregation.

Although exemplary embodiments of the present invention have been described, it will be understood by one of ordinary skill that various modifications and variations may be made thereto without departing from the essential characteristics of the present invention. The exemplary embodiments disclosed herein are provided merely for purposes of describing the invention and the present invention is not limited thereto. The scope of the invention should be interpreted based on the appended claims and all technical spirit of the equivalents of the invention should be construed as included in the scope of the invention.

What is claimed is:

1. A method of transmitting user equipment (UE) capability information in a multiple component carrier system by the UE, the method comprising:
receiving a UE capability request message from a base station (BS); and
transmitting, to the BS, a UE capability response message, which includes a supportedbandcombination field indicating one or more band combinations supported by the UE, and multiple timing advance (MTA) capability field indicating each of multiple timing advances supported by the UE corresponding to each of the one or more band combinations.

2. The method of claim 1, wherein the maximum number of the supported band combinations is 128.

3. The method of claim 1, wherein whether the MTA is supported by the UE is defined for each of the one or more band combinations.

4. The method of claim 1, wherein at least one band included in the band combination is classified into a component carrier (CC) class,
and wherein the CC class is defined by aggregated transmission bandwidth, maximum CC number and nominal guard band.

5. A user equipment (UE) for transmitting a UE capability transfer procedure in a multiple component carrier system, the UE comprising:
an RF unit to receive, from a base station (BS), a UE capability request message; and
a message processor to configure a UE capability response message including a supportedbandcombination field indicating one or more band combinations supported by the UE, and multiple timing advance (MTA) capability field indicating each of multiple timing advances supported by the UE corresponding to each of the one or more band combinations.

6. The UE of claim 5, wherein the RF unit supports the supported band combinations up to 128.

7. The UE of claim 5, wherein the RF unit defines whether the MTA is supported by the UE is defined for each of the one or more band combinations.

8. The UE of claim 5, wherein the RF unit classifies at least one band included in the band combination into a component carrier (CC) class, wherein the CC class is defined by aggregated transmission bandwidth, maximum CC number and nominal guard band.

9. A method of receiving user equipment (UE) capability information in a multiple component carrier system by a base station (BS), the method comprising:
transmitting a UE capability request message to a UE; and
receiving, from the UE, a UE capability response message, which includes a supportedbandcombination field indicating one or more band combinations supported by the UE, and multiple timing advance (MTA) capability field indicating each of multiple timing advances supported by the UE corresponding to each of the one or more band combinations.

10. The method of claim 9, wherein the maximum number of the supported band combinations is 128.

11. The method of claim 9, wherein whether the MTA is supported by the UE is defined for each of the one or more band combinations.

12. The method of claim 9, wherein at least one band included in the band combination is classified into a component carrier (CC) class,
and wherein the CC class is defined by aggregated transmission bandwidth, maximum CC number and nominal guard band.

13. A base station (BS) for receiving user equipment (UE) capability information in a multiple component carrier system, the BS comprising:
a message processor to generate a UE capability request message; and
an radio frequency (RF) unit to transmit, to a UE, the UE capability request message and to receive, from the UE, a UE capability response message, including a supportedbandcombination field indicating one or more band combinations supported by the UE and multiple timing advance (MTA) capability field indicating each of multiple timing advances supported by the UE corresponding to each of the one or more band combinations.

14. The BS of claim 13, wherein the maximum number of the supported band combinations is 128.

15. The BS of claim 13, wherein whether the MTA is supported by the UE is defined for each of the one or more band combinations.

16. The BS of claim 13, wherein at least one band included in the band combination is classified into a component carrier (CC) class, and wherein the CC class is defined by aggregated transmission bandwidth, maximum CC number and nominal guard band.
